(19) United States
(12) Patent Application Publication
(10) Pub. No.: US 2017/0200170 A1
(43) Pub. Date: Jul. 13, 2017

(54) METHOD FOR STORING, DELIVERING, AND DISPLAYING DOCUMENTATION AND CREDENTIALS RELATED TO INTRASTATE AND INTERSTATE COMMERCE

(71) Applicants: William Joseph Curry, JR., Fairfax, VA (US); Joanna Masny, Scottsdale, AZ (US); Michael Holloman, Scottsdale, AZ (US)

(72) Inventors: William Joseph Curry, JR., Fairfax, VA (US); Joanna Masny, Scottsdale, AZ (US); Michael Holloman, Scottsdale, AZ (US)

(73) Assignee: Legatus Solutions Corporation, Herndon, VA (US)

(21) Appl. No.: 15/401,661

(22) Filed: Jan. 9, 2017

Related U.S. Application Data
(60) Provisional application No. 62/276,541, filed on Jan. 8, 2016.

(51) Int. Cl. G06Q 30/00; G06F 17/30

(52) U.S. Cl. CPC G06Q 30/018; G06F 17/30719; G06F 17/30011

(57) ABSTRACT

A method and apparatus for one office, such as a State's fuel tax licensing bureau, to deliver an electronic/digital certificate to a licensee's “folder” and allow an authorized user to share a link to that object. This solves the three key problems: object delivery and provenance, allowing the issuer to set or update the obsolescence characteristics of the credential; easy accession by the receiving entity; and ability to accumulate the related documentation and share, electronically via a network (such as the internet). Since these links are managed by the new service, any participant need only have internet and/or email access.

### RELATED APPLICATIONS

This application claims the benefit of U.S. Provisional Patent Application No. 62/276,541 filed Jan. 8, 2016 bearing the same title and inventors. U.S. Provisional Patent Application No. 62/276,541is hereby incorporated by reference as if repeated herein in its entirety including the drawings. This application is also related to U.S. patent application Ser. No. 14/456,518 filed Aug. 14, 2014 which in turn claimed priority to U.S. Provisional Patent Application No. 61/918,119 filed Dec. 19, 2013. U.S. patent application Ser. No. 14/456,518 and U.S. Provisional Patent Application No. 61/918,119 are hereby incorporated by reference as if repeated herein in their entirety including their drawings.

### BACKGROUND

The present invention relates generally to computerized methods and systems for creating, maintaining and processing of records, and more particular to a method and system for creating, maintaining and processing of records related to the regulation of intrastate and interstate commerce involving motor carriers.

The administration of the functions and information to support and comply with the wide variety of registration, certification, regulatory, and taxation requirements in North America is a difficult endeavor. Various stakeholders involved in such commerce have to maintain volumes of records, provide records and summaries to (and among) various governments in both the United States and Canada, and produce those records and summaries in a wide variety of forms and contexts. As yet, there is no usable facility to share this information and artifacts.

The present invention solves vexing problems in records and credential management. For example, the U.S. Government has long sought to encourage the provision of “electronic credentials” to support various highway programs in the United States. For example, the United States Department of Transportation (USDOT) Federal Motor Carrier Safety Administration (FMCSA) has spent millions of dollars in the Commercial Vehicle Information Systems and Networks (CVISN) program, which includes (as one core requirement) the provision of electronic credentials by participating U.S. States. In working groups to include the CVISN community, interstate cooperatives, the American Association of Motor Vehicle Administrators (AAMVA), the participating U.S. and Canadian jurisdictions within the International Registration Plan (IRP) have, in the past, sought to solve this problem. In fact, the participants of the International Fuel Tax Agreement (IFTA) are even now trying to form a solution to the problem of producing usable and verifiable fuel tax licenses. (Both IRP and IFTA electronic credentials are requirements under CVISN.)

Certainly, issuing jurisdictions can provide credentials in an electronic or digital form—this is done frequently and by most jurisdictions—but there is no practical method for sharing these credentials with the tens of thousands of government agencies (to include over 19,000 law enforcement agencies in North America). Similarly, insurance companies would like to distribute electronic credentials, but the impracticability associated with the credential distribution inhibits this. Various techniques have been proposed and tried, such as sending the images or documents to a cell phone, but each technique suffers from the same problems: accessibility without handling the registrant/licensee electronic device, inability to validate the credentialing source or current validity.

The insurance credentialing is just one example. It is an easy matter for the insurance company to send an insurance card to a covered party, and certainly the covered party could display this on a smartphone or tablet. Even if an inspecting official would want to handle the electronic device—and acceptance of this approach meets with resistance due to liability, evidentiary, and hygiene issues—there is no practical manner to validate that the policy is still in force. These same issues vex vehicle registration cards and permits, fuel and sales tax licensing and receipts, insurance, drivers' credentials, cargo waybills, trip records, toll receipts, and many other artifacts.

### SUMMARY OF THE INVENTION

The present invention, referred to as the mServices Communication Center or mServices Secured Credentialing CloudTM, solves these and other problems by providing a method and apparatus for one office, such as a State's fuel tax licensing bureau, to deliver an object, such as an electronic/digital certificate, to a licensee's “folder” and allow an authorized user to share a link to that object. This solves three key problems: object delivery and provenance, allowing the issuer to set or update the obsolescence characteristics of the credential; easy accession by the receiving entity; and ability to accumulate the related documentation and share, electronically via a network (such as the Internet). Since these links are managed by the new service, any participant need only have Internet and/or email access.

Others have patented systems for collecting driver information (i.e., hours of service), but the present invention facilitates the exchange of digital information, and combines the information for using the data for variety of programs into other systems, such as U.S. patent application Ser. No. 14/456,518 entitled “Method and Apparatus For Preparing, Storing and Recording Compliant Records For Motor Carriers, Registrants, and Governmental Organizations” filed Aug. 11, 2014 which is hereby incorporated by reference herein as if repeated herein it its entirety, including the drawings. The present invention provides a novel technique for credentials, such as a registration card, a fuel tax license, an overweight permit, a medical card, an insurance card, a driver's license, etc., to be stored and made available to third parties with appropriate verification and authentication to such third parties.

The following patents disclose electronic credentials: U.S. Pat. No. 9,009,811; U.S. Patent Application Publication No. 2014/0222682; U.S. Pat. No. 6,980,093; U.S. Pat. No. 8,442,508; and U.S. Patent Application Publication No. 2013/0226397.

Moreover, there are a few pilot programs oriented to distribution of indicia via pdf files/images or raster images to the applicant, but there are several weaknesses with these approaches. One concept is to email the credential and let a driver give the cell phone or tablet to law enforcement (this is completely impracticable for several reasons, from liability to evidentiary to hygiene). Moreover, anyone can hack an image and forge it. No current solution allows a viewer to an electronic credential to the submitting request information to verify that the credential is accurate. Merely delivering the credentials in a digital or electronic format to the applicants does not suffice, since this method does not facilitate access to the range of persons or entities that have legitimate needs to access the data objects, with their own systems, in a manner that clearly identifies the originator of the data object.

The communications center of the present invention allows the public or private agency to accept and respond to applications for credentials by associating the resulting credentials in a secure “wallet” or “folder” in a manner that preserves the provenance of the different data objects involved. This means that the viewer or user of any data object may verify the creator of the object, when it was created, and actually view the object through a network (such as the internet) with everyday tools (such as electronic mail or an internet browser).

As the MSCC “find” and “deliver” functions are used, data objects are provided to recipients along with data and metadata that identifies the registered owner and creator of the data. In this way, proper provenance of the data is always maintained. If a recipient changes that data, or even registers that data as a new copy, then the data and metadata are registered as a separate object(s) as owned by the new registered owner and creator. In addition to the provenance information provided to recipients, MSCC has the records and ability to verify the date, time, version, and secure registration client for each object.

In the typical “electronic credential,” the actual data/object is a copy or mere data that purports to represent the information contained within the credential, and not the actual credential as provided by the creating entity.

The communications center of the present invention also enables a user to develop a set of folders, which organizes the information in manner that is digitally similar to driver logbooks today. Because the folders are organized by links to version-controlled links to data objects (and not copies of the objects that could have been hacked or forged), and because the folder itself is an object, a user may securely send a link to any other recipient (whether or not an authorized user), and that recipient may browse, download, or copy those data objects. This same model applies to a wide range of governmental functions, including in a wide variety of commerce and transportation modalities.

According to one aspect of the present invention, a method for providing electronic credentials to a licensee or registrant and a third party from an electronic data storage system includes delivering by an issuer of an electronic credential a digital certificate representative of the electronic credential to a licensee's folder stored in the electronic data storage system and enabling an authorized user of the licensee to share a link to a received digital certificate in the licensee's folder. The method further includes allowing the issuer to set or update an obsolescence characteristics of the digital certificate; and sharing the link over a public network via a communications system to the third party.

In this exemplary embodiment the communications system may include a text messaging system, an electronic mail system, and a file transport protocol system.

The method may also include displaying the digital certificate on a computer display, on a laptop computer display, an electronic tablet, a portable communications device display, a smart phone, and a portable computing device display.

In this method, the data storage system may store data relevant to vehicle registrations.

This method may include sharing by the owner or creator of data access to distance information and summaries.

This method may include requesting actions by the owner or creator of data, tracking the accession of data objects, recording actions undertaken by a participant, and recording by a participant resulting data from the actions taken.

In this method, the data storage system may store data relevant to fuel tax reporting.

This method may include sharing by an owner or creator of data access to distance information, fuel receipts and summaries.

In this method, the data storage system may store data relevant to motor carrier, registrant and shipper functions.

This method may include recording by a participant resulting data from the actions taken, including recording the electronic (digital) credentials.

This method may include enabling a participant to be authorized an ability to review, confer accession rights to others, and cause the data or a link to the data to be sent via one or more methods to participants and non-participants.

According to another aspect of the present invention, an exemplary embodiment of an apparatus for providing electronic credentials to a licensee and a third party includes a data storage system, a communications system and a processor. The data storage system stores one or more electronic credentials in one or more folders. The communications system delivers from an issuer of an electronic credential a digital certificate representative of the electronic credential to a licensee's folder stored in the data storage system. The processor enables an authorized user of the licensee to share a link to a received digital certificate in the licensee's folder, and allows the issuer to set or update an obsolescence characteristics of the digital certificate, and enables the user to share the link over a public network via the communications system.

In this apparatus, the communications system may include a text messaging system, an electronic mail system a file transport protocol system, or a computer display to display the digital certificate.

This apparatus may include a laptop computer to display the digital certificate, an electronic tablet to display the digital certificate, a portable communications device to display the digital certificate, a smart phone to display the digital certificate, or a portable computing device to display the digital certificate.

In this apparatus, the data storage system may specific relevance to vehicle registrations.

In this apparatus, the processor may enable an owner or creator of data to share access to distance information and summaries.

In this apparatus, the processor may enable an owner or creator of data to request actions.

In this apparatus, the processor may track accession of data objects.

In this apparatus, the processor may enable a participant to record actions taken.

In this apparatus, the processor may enable a participant to record resulting data from the actions taken.

In this apparatus, the data storage system may store data relevant to fuel tax reporting.

In this apparatus, the processor may enable an owner or creator of data to share access to distance information, fuel receipts and summaries.

In this apparatus, the data storage system may store data relevant to motor carrier, registrant and shipper functions.

In this apparatus, the processor may enable a participant to record resulting data from actions taken, including storing the electronic (digital) credentials.

In this apparatus, the processor may enable a participant to be authorized an ability to review, confer accession rights to others, and cause the data or the link to the data to be sent via one or more methods to participants and non-participants.

According to another aspect of the present invention, an exemplary embodiment of a communications apparatus enables one or more organizations to control and share data between and among users while the contributing organization continues to maintain version and access control over the shared data. The apparatus includes computer software in the form of non-transitory computer readable media, having encoded thereon instructions to cause a processor to enable an organization of the one or more organizations to deliver a data object to a collection of data objects, to a folder of collections, and to enable the user to share a link to this data object to other systems and other users. The instructions also permit the other users to verify a creator of the data object and a creation date of the data object. The instructions include a deliver function, and the deliver function causes the processor to deliver the link to a requested data object along with an associated metadata that identifies a registered owner and a creator of the requested data object. The instructions further cause the processor to register any changed data or new copies of data as a new data object owned by a modifier of the changed data or a creator of the new copy of the data. The instructions also cause the processor to record and verify a date, time, and version and secure registration client for each data object. The object consists of only an instruction to locate a data file stored under control of the organization. The instructions to further enable the organization to define an obsolescence characteristic for the object and permit an organization to be self-nominating to the communications apparatus. The organization is then assigned a private key to identify itself once verified. A communications device is included to send the link to a user's designee.

### BRIEF DESCRIPTION OF THE DRAWINGS

FIG. 1 depicts an exemplary embodiment of a process for storing and sharing electronic credentials according to one aspect of the present invention in a high level fashion.

FIG. 2 highlights an exemplary embodiment of a data model that is used by the communications center of the present invention, which data model describes user profiles and data profiles according to another aspect of the present invention.

FIG. 3 provides a list of the core functions of an exemplary embodiment of software according to yet another aspect of the present invention.

FIGS. 4A-D provide additional details of the Communication Center functions according to still another aspect of the present invention.

FIG. 5 depicts multiple computer servers, in different locations, cooperating to provide access to the same set of data objects.

FIG. 6 depicts a variety of structured data sets that are administered by various governmental organizations in the United States that relate information about regulated or credentialed entities, for which there exists no current universal method to store or share related information.

FIG. 7 depicts an exemplary embodiment of a dialog manager for the Communications Center of the present invention.

FIG. 8 depicts an exemplary embodiment of an apparatus for interacting with various entities to provide electronic credentials according to yet another aspect of the present invention.

FIG. 9 depicts an exemplary embodiment of a more specific use of the process shown in FIG. 1 according to another aspect of the present invention.

FIG. 10 depicts an exemplary embodiment of a simpler data model than that shown in FIG. 2.

### DETAILED DESCRIPTION

The mServices Communication Center (MSCC) is a core function of the mServices architecture, and provides an archival-quality repository for the mCarrier ecosystem. The mServices layer is a service layer that is not intended to have direct “regular” user interaction. The services will be publicized for use by “participating applications.”

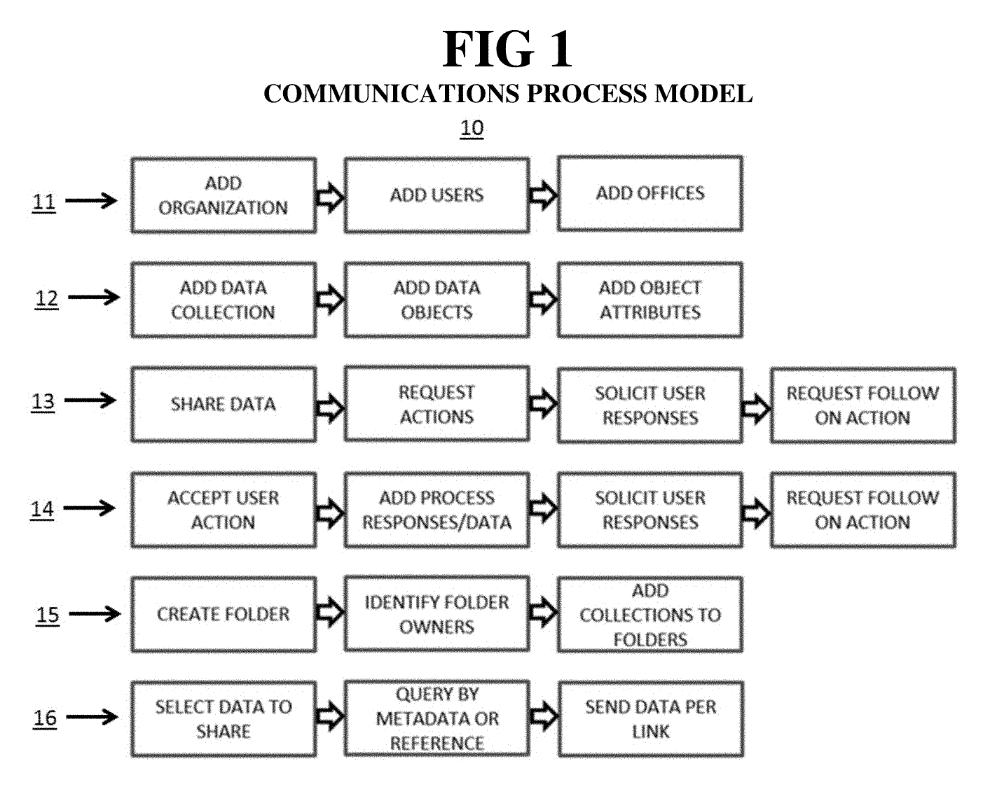

Turning to FIG. 1, shown therein is the communications process model 10. Since the communication center (termed the mServices Communication Center, or MSCC) of the present invention intends to infer relationships, similar to a social network, rather than the typical “top down” approach taken by the usual business system, organizational entities will be “self-nominating,” except that the organization itself will be added on proof of existence and given a private key by which to identify itself. In this way, the communication center administrative module will protect the existence of the organization, but service request that is made by the organization will cause the creation of new users and new offices. The process of self-nomination simplifies the interactions between the communication center and the applications that use it, and confers to the applications the ability to manage its own usage of the communication center.

FIG. 1 row 11 shows that the added organization will have the functional ability to add users and offices. In FIG. 1 row 11, a rough overview of the use of the MSCC shows that authorized organizations have users and offices. More precisely, an organization must be defined to the system, and users and offices may be defined. A user may belong to zero or more offices, and an office may have zero or more users defined in them.

FIG. 1 row 12 depicts that an authorized organization may add a data “collection” which will be able to identify many “objects”. In this form, a collection may be likened to an envelope that could have various documents, images, data files, movie clips, or any data that may ultimately be stored as a single file (even if the single file itself is an archive with one or more files within it). Within the collection, the organization will be able to define a range of process-relevant attributes for each data object. For example, an envelope may contain an application for a driver's license along with an image of the applicant's birth certificate, passport, visa, and driving record. In this example, the user may be asking a governmental agency to issue a driver's license, using the attached application and supported by the variety of objects contained within; so, at FIG. 1 row 13, an authorized user will share the data and request actions for the governmental agency, defining which responses and/or follow on actions are being requested.

In turn, the government agency may (in row 14), indicate acceptance of the user action, take action and distribute the results of the action—noting that the result may be a request for further evidence, an invoice for the work, and so on, leading to the actual credential in this example.

Often in our world, entities (a user, an office, or an organization) need to share information amongst themselves or with other entities. The organizing method we often use is to create a folder, such as the many folders we have in file cabinets. The communications center will emulate this method of organization, simply by creating a “folder” type of collection (at FIG. 1, row 15) that may contain other folders, and an authorized user will be able to share data at the individual object, a collection, or a folder level simply by requesting that the communication provide a simple internet link to the shared data (FIG. 1, row 16).

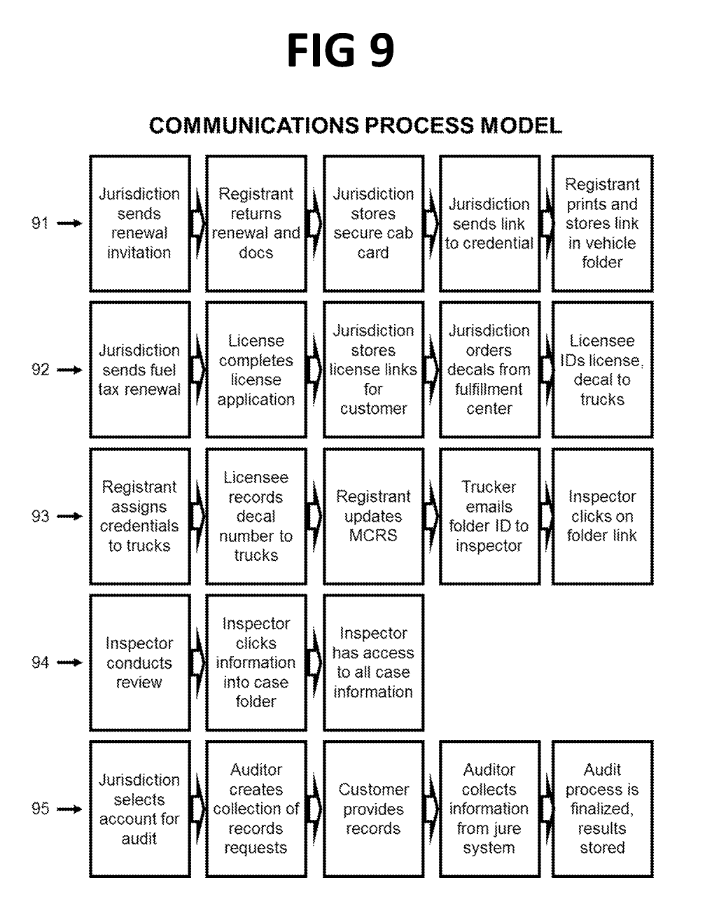

FIG. 9 shows a set 90 of related business use cases for vehicle credentialing and related processes. The first set of processes at row 91 show the application for and credentialing of a vehicle's registration. Per interjurisdictional and federal requirements, these are performed periodically, typically annually, and the distribution of up to date cards to millions of vehicles is problematic. This use case solves that problem.

At 92, the similar process for a fuel tax sales license renewal, per the International Fuel Tax Agreement, is issued annually for the calendar year.

At 93, the registrant assigns the credentials to vehicles, can complete other information that is currently missing in the design of the Federal Motor Carrier Safety Administration's SAFER and PRISM programs, and then can share that data with the inspector. This can close the gap that is evidenced by monthly reports from the Federal Government that identifies inconsistent data to the States.

At 94, the inspector can use MSCC as well as Federal Systems, such as SafetyNet, to complete the inspection. At 95, similar processes by the jurisdictions to fulfill inter-jurisdictional obligations for fleet audits can be facilitated and results stored within the MSCC.

FIG. 9 shows how the communications process model of FIG. 1 can be adapted to a specific implementation for electronic credentialing 90. Thus in row 91, a jurisdiction sends renewal invitation, a registrant returns renewal and documents, the jurisdiction stores secure cab card, the jurisdiction sends a link to credential, the registrant prints and stores the link in vehicle folder.

In row 92, a jurisdiction sends fuel tax renewal, licensee completes license application, jurisdiction stores license links for customer, jurisdiction orders decals from fulfillment center, and licensee IDs license, and decal to trucks.

In row 93, registrant assigns credentials to trucks, licensee records decal number to trucks, registrant updates MCRS, trucker emails folder ID to inspector, and inspector clicks on folder link.

In row 94, Inspector conducts review, Inspector clicks information into case folder, and Inspector has access to all case information.

In row 95, Jurisdiction selects account for audit, Auditor creates collection of records requests, Customer provides records, Auditor collects information from jure system, and Audit process is finalized, results stored. Interactions among jurisdictions and customers are simplified.

Thus, the communications center of the present invention solves digital credential and records management to and among fleets. Logbook folders can be emailed, in whole or part, thereby solving problems of access, distribution, archiving.

A uniqueness of the invention is that even with data that is shared, a user must meet the security requirements of an individual object in order to access that object. This means that an authorized user could release some, but not all, objects for viewing, and then send a link for an entire collection to a user—but the user would only be able to access the objects released at the time of data accession. The communications center allows a user to share an endless amount of data with others, but the owner of the data can grant and revoke access at any time. This is an important twist to the invention that differs dramatically from the physical file cabinet analogy, in that users can set up shares but data owners can logically partition the data it wishes to release, as in an unlimited number of secure lockboxes within the folders and collections.

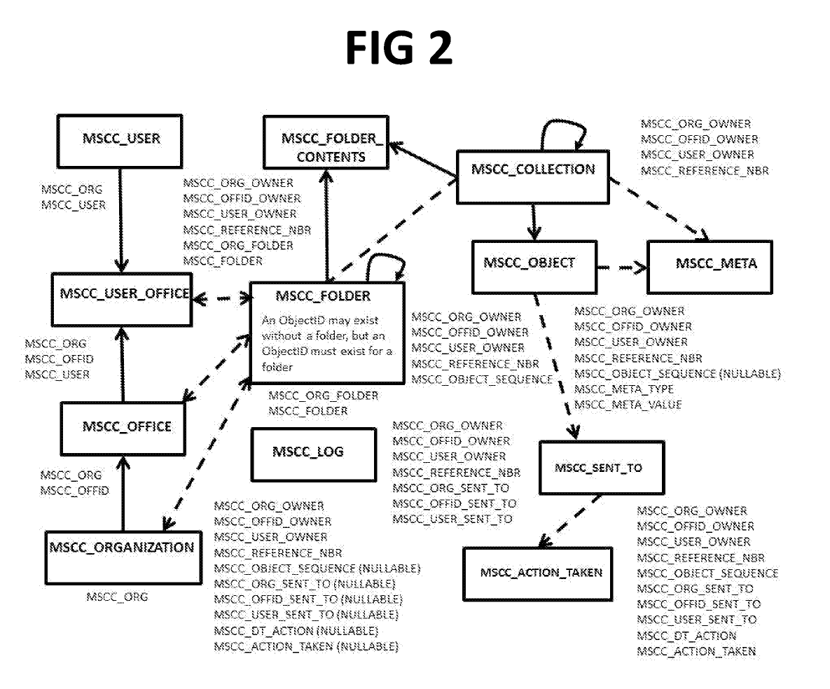

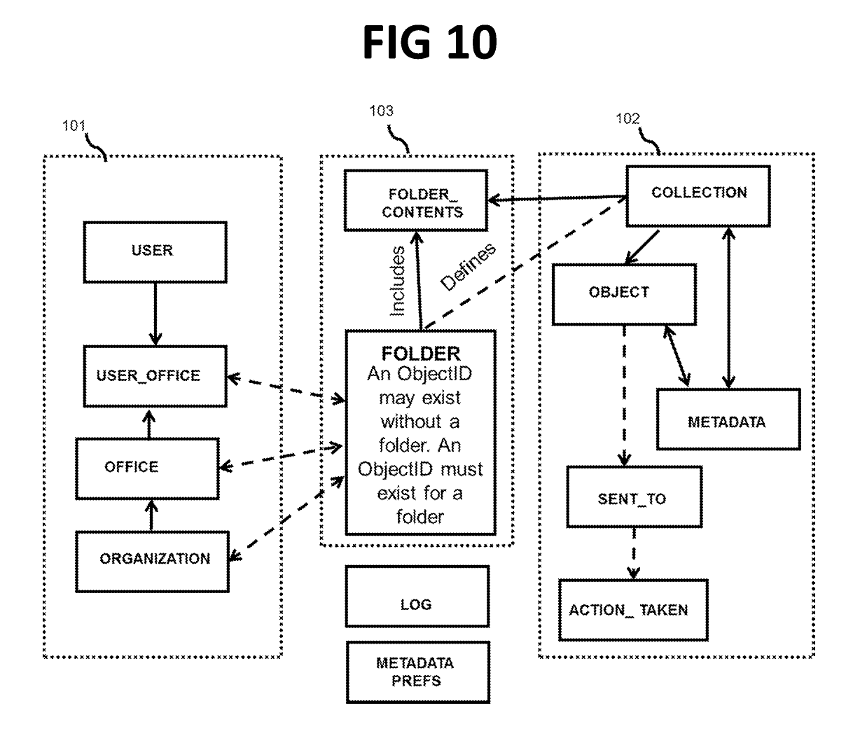

FIGS. 2 and 10 highlight the data model that is used by the communications center; this data model describes the user profiles and the data profiles. FIG. 10 highlights the major aspects of the data stored for the data in MSCC. As described above, Collections of Objects (see 102) may be stored, described, and shared; these objects may be data in the form of structured or unstructured data strings or computer files, or instructions to get data or files. The ability to manage this data via a web service and client software is important to open-system based management of the MSCC information. Allowing participating applications to define which objects may be shared by ecosystem participants is important, and MSCC allows searching objects via both key and metadata values. FIG. 2 shows additional details, to include “keys” to the relationships of data within the database.

The core (initial) mServices Communications Center functions are given in FIG. 2. Additional features will be added, notably the ingest of collections and objects from various sources, such as in-coming electronic mail. In FIG. 10 element 101, the relationships between organizations, organization offices, and users are defined. Each user is defined by membership in exactly one organization (a person belonging to multiple organizations would be viewed by the system as different users), and within zero or more offices in that organization.

FIG. 10 element 102 displays the data architecture, where a collection has zero or more objects, and the objects may be “sent to” zero or entities. A collection is a group of objects, likely related in some way, to include any type of data file that may be stored. An object itself is, in the communications center, only the metadata of the data that includes a link (such as a universal resource locator, or internet URL) to the object. The mechanism for actually storing the data object is left to commercial systems, such as those offered currently by Dropbox.com, Google, Microsoft, and others.

The object registration attribute MSCC_OBJECT_LINK is a resource locator in MSCC. It can be a fully-qualified file path. But this could be different. For example, if the resource is a dropbox file, the file will be moved out of the server's (or participating application's) dropbox folder into a different location (e.g., within dropbox, at Amazon Web Services or in a file vault). Each object is distinguished by a sequence number within the collection, and an object may be an instantiation of data, file, or method. If data, that data is stored within the MSCC Object record itself. If the object is a file or method, then the object will be distinguished by an MSCC “fileid” and a resource locator (“MSCC_OBJECT_LINK”) will define the file path or instruction. An instruction may be a widely published and applied application protocol (such as hypertext transfer protocol, file transfer protocol, or extensible mark-up language), or a method that is agreed to by MSCC and application developers.

As shown in FIG. 10 element 103, a folder structure is employed to allow for the aggregation of collections, for convenience of reference by entities. A folder object is, itself, a collection and therefore the participating computer applications control the sharing and usage of folders in a manner that is highly consistent with a collection. Additionally, this structure allows a folder to contain other folders, and this provides an unlimited amount of flexibility to the applications that use the communications center. Similarly, an object may be included in many collections—a digital analogy to “paper copies” but with the added significant feature to continue to manage accession rights, and record accession history, for the objects across all collections.

The folder structure and the “sent to” characteristics of the object structure allow an authorized user to organize, and share, data for a variety of business purpose to include submission of applications for processing, publication of artefacts for retrieval, for general or specific reference, and so on.

When taken together, the invention satisfies a number of related problems in managing the dialog among people and systems. First, the data is easily accessed because the system uses commercial, internet “cloud” systems and actual distribution of the data is performed by providing a link—not actually transmitting the data object. This provides unlimited portability. Second, a collection's “owner” retains the ability to grant and revoke access. This means that an application using the communications center can remove accession rights for expired credentials. Third, the communication center provides a simple method for applications to generate action items and responses, without having to coordinate in advance with the communication center administers. Fourth, the communication center records not only the accession rights that have been granted but also the history of accesses, to eliminate disagreement on exactly what was provided and when it was used—this is useful in a wide range of business applications for both user-oriented and inter-system communications to record both data requests and data responses.

The communication center offers additional flexibility, because of the expansive metadata library for each object. The metadata is specific to the industry and functionality, and can be generalized to allow an application to use its own data system to find subjects of interests and then make the metadata query to the communications center, which, in turn, will return links and/or data objects to information meeting the search criteria and within the requestor's accession rights, applying specific preferred format renderings where available and sending it to the recipients while specifying recipient address, reply-to instructions, and return-path (error processing) handling.

The metadata specification provides flexibility to the design and retrieval of data within the mServices Communication Center, while also enabling participating applications to learn which metadata classes are appropriate to which data objects. By reviewing the metadata attributes assigned by participating applications, the mServices Communication Center will accumulate statistical information for applications to apply. In this way, the mServices Communication Center helps different participants to move towards a common lexicon for each object type.

The mServices Communication Center of the present invention is a new approach to inter-organizational coordination by integrating new services with existing and evolving Internet infrastructures. The invention is a set of computer programs and data structures that allow participating computerized applications to Add, Remove, Find, and Deliver data throughout and among the participating applications, as well as to set data access permissions, assign and record actions, and update the description of the included data via metadata that is relevant to the particular business functions.

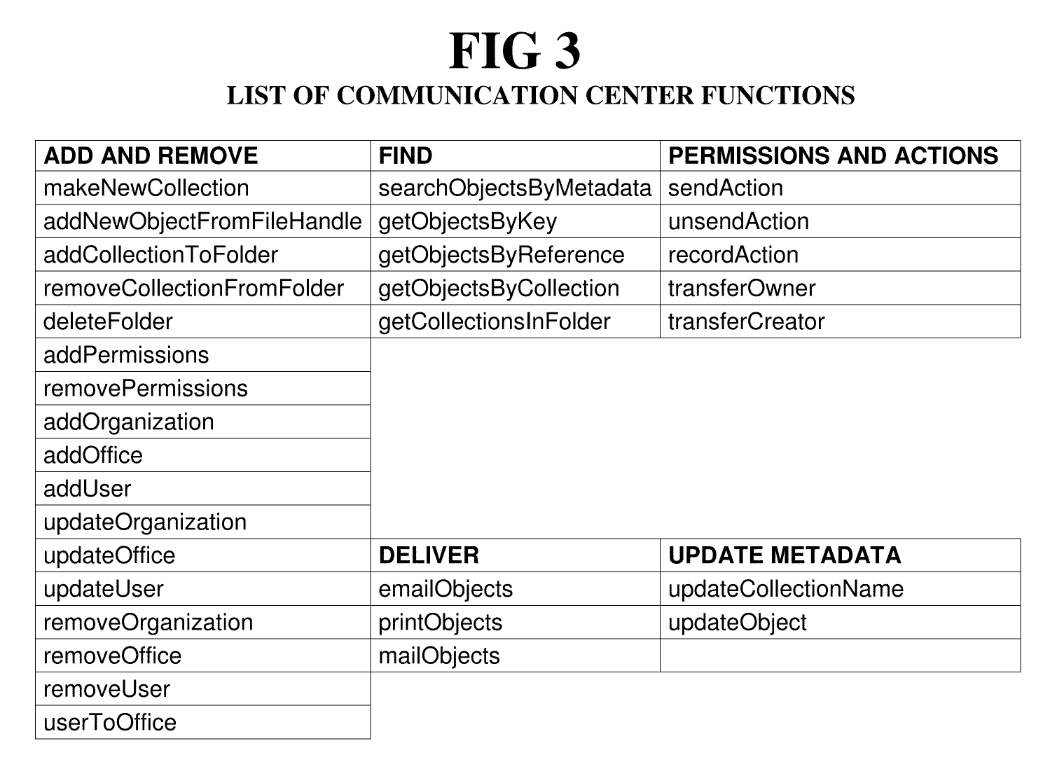

FIG. 3 provides a list of the core communication center functions of the software. These core functions allow participating and authorized applications to store and maintain data, and to exchange the data in any format with other authorized applications. Moreover, a participating application can even deliver the data to other resources that are not directly associated or known to the Communication Center, such as via email, regular mail, and printing or facsimile.

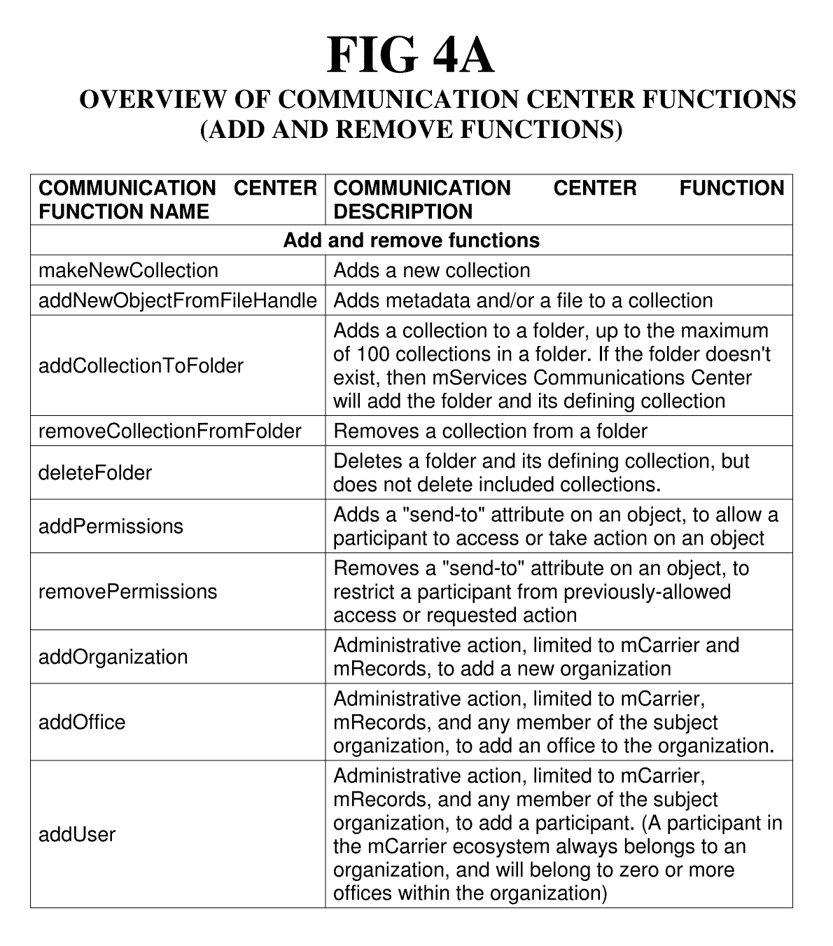

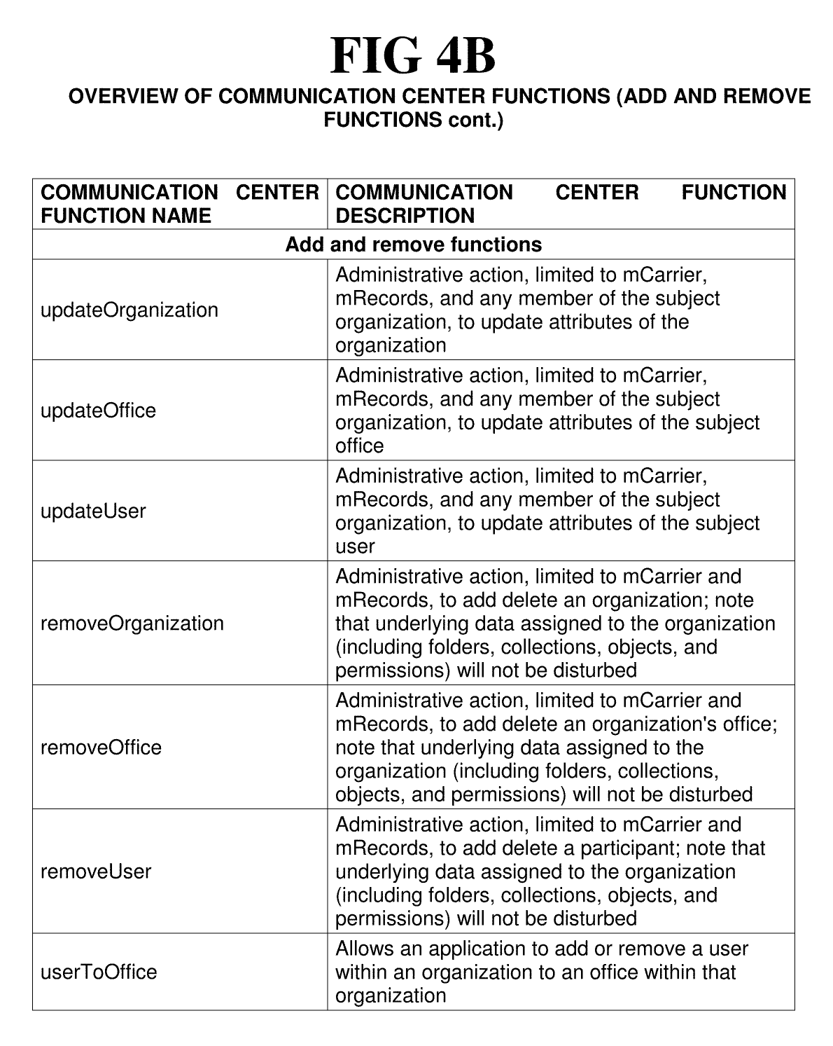

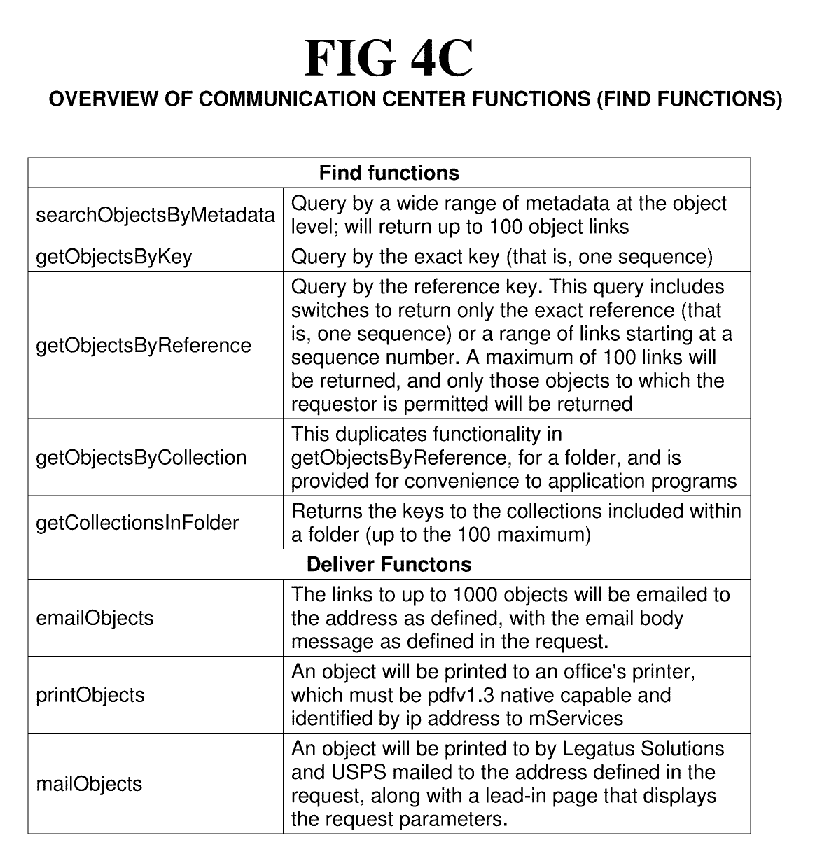

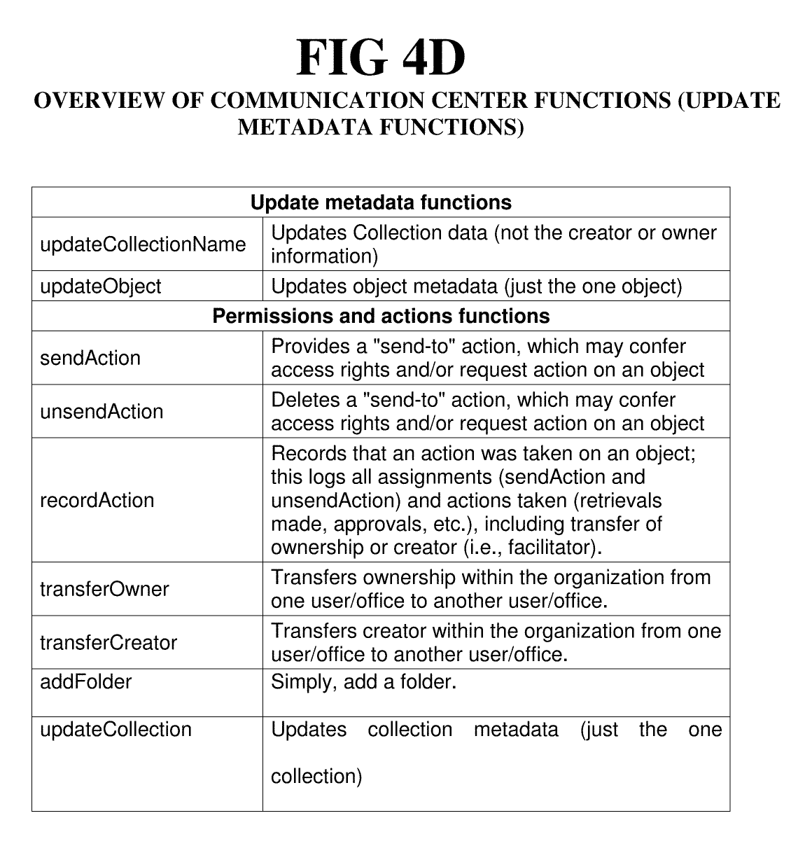

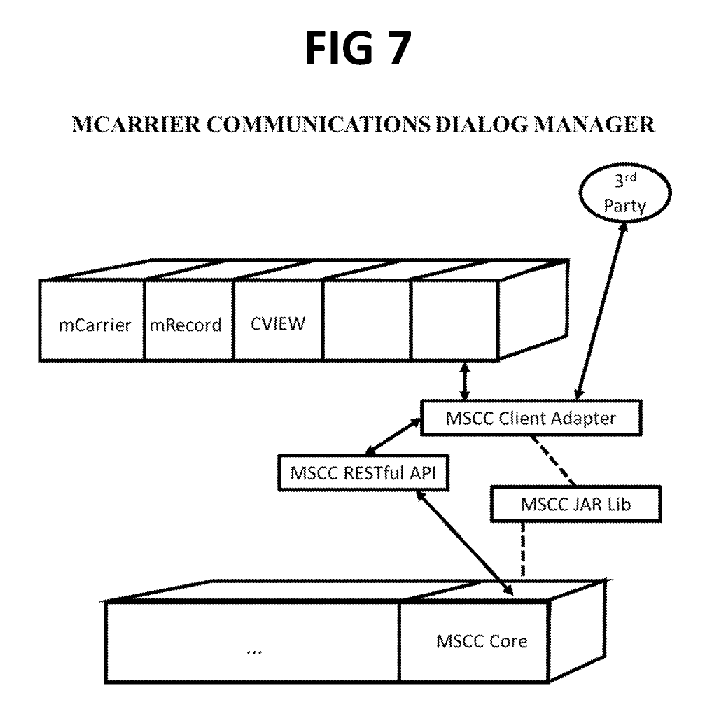

FIGS. 4A-D provide additional detail of the Communication Center functions. The Communications Center services are built to constrain a client/server architecture to use a stateless communication protocol, typically HTTP. Clients and servers exchange representation of resources by using COMMUNICATION CENTER RESTful services. It provides uniform interfaces and provides stateful interactions through hyperlinks and caching. See FIG. 7.

FIG. 7 is an instantiation of the usage of the MSCC by participating programs. The MSCC system provides a client adapter—in its current instantiation a Java ARchive file) with a specific “token” that allows the MSCC Core server to trust that particular client, which is specific to the Organization. This JAR may be issued to and used by a participating application system, whether a part of the mCarrier set of products or not.

FIG. 5 displays example interactions of the participating systems and the MSCC. In this example MSCC uses its hardware, network, and software to store and apply methods to acquire, organize, and provide information on demand to systems and users of systems.

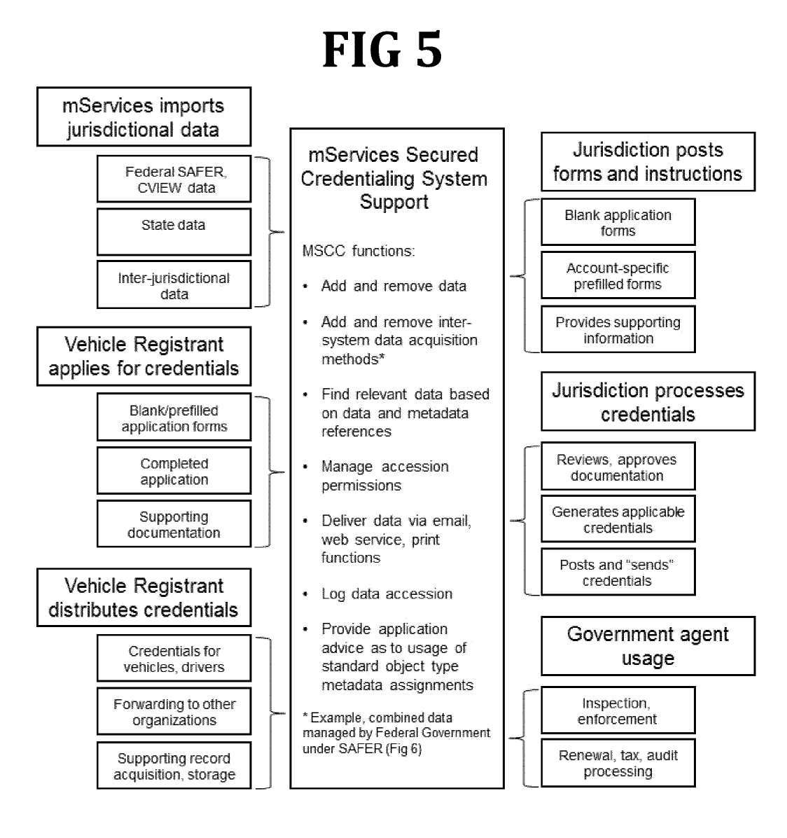

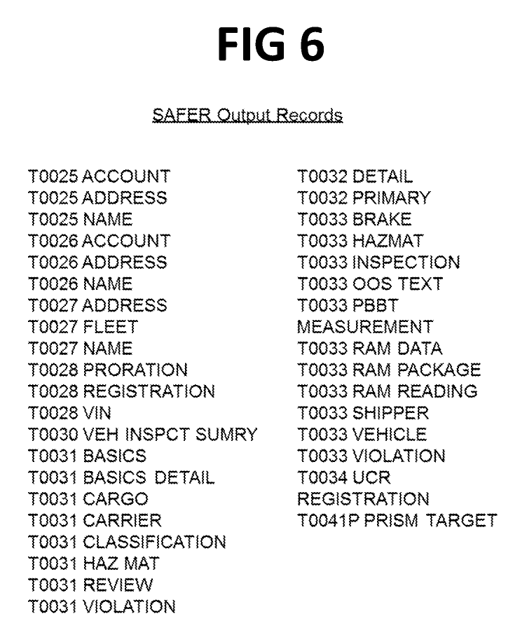

In this example of the usage mServices can access information provided by the federal government (SAFER, CVIEW data for examples as shown in FIG. 6), jurisdictional information (such as DMV vehicle title and registration data or instructions to obtain the data), and other inter-jurisdictional (such as fuel tax license demographic data). This data can be used by jurisdictional motor vehicle administrators to merge with their standard forms to generate unfilled or prefilled application forms for registration, fuel tax, audit queries, and so on. Then, an entity can complete the credential application form and supply its own forms and supporting documentation following the jurisdictional guidance. The jurisdiction then apply its business rules to review, approve, and process the applications to issue the required credentials. Even with the varied methods that MSCC has in data distribution, the registrant would have the ability to access its valid or expired credentials per the rules set by the jurisdiction, to include enabling access by other government agents, such as vehicle and fleet inspectors, auditors, and border stations.

There are a number of functions to allow the participating applications to add and remove data to the system, and these function requests and responses may be elaborated further by the client and server components as the present invention is used

Function makeNewCollection

Service request by a trusted site (mCarrier or mRecords), indicating that it wants to create a new object. Requestor will provide a MSCC_ORG_OBJECT_REFERENCE along with the required object identification (MSCC_ORG_OWNER, MSCC_ACCOUNT_OWNER, MSCC_SUB_ACCOUNT_OWNER, and MSCC_OFFID_OWNER), or the service will assign a reference number. The requesting service may specify an object reference, and the response will confirm that the reference is unique or reject the transaction (NOT UNIQUE). Requestor may also provide other data that will be created in table MSCC_COLLECTION, and validate all information about the requestor and owner attributes (that is, they must be legal). If requestor specifies an office ID that does not yet exist, mServices Communications Center will create that office (within the ORG). If requestor specifies a folder (again, within the Organization) that doesn't exist, mServices Communications Center will create the folder). The owner will be added to that new office. If the office did exist and the owner is not a member of the office, then the transaction will be rejected (NOT AUTHORIZED). If successful in creating the new object, mServices Communications Center will respond with appropriate data that defines its keys, and the requestor can then start to supply additional information. Each service request includes a response status; these are defined in the Communications Center database codes table. Responses include codified indications of: SUCCESS, NOT UNIQUE, NOT AUTHORIZED.

Function addNewObjectFromFileHandle

This trusted service intends to add content to the Collection, typically from mRecords or mCarrier. The Collection is a header, and specific context and content is provided in MSCC_OBJECT entries. There may be several objects associated with a Collection—each new object will be saved via a separate call. If the requestor wants to save 10 documents for one object (maybe 10 trip reports), then there will be one makeNewCollection and at least 10 addNewObjectFromFileHandle calls. Requestor will provide, at a minimum, the “MSCC_ORG_OWNER” “MSCC_ACCOUNT_OWNER” MSCC_SUB_ACCOUNT_OWNER” “MSCC_OFFID_OWNER” and “MSCC_HALFALOGUE_START_TS” of the owning Collection. Requestor may include one file handle (only mCarrier or mRecords can specify a file handle, which is to a file stored in Dropbox.) Requestor may also provide other data that will be created in table MSCC_COLLECTION, but mServices Communications Center is only responsible to validate all information about the requestor and owner attributes (that is, the keys must be legal). If requestor specifies an office ID that does not yet exist, mServices Communications Center will create that office (within the ORG). If requestor specifies a folder (again, within the ORG) that doesn't exist, mServices Communications Center will create the folder).

Note about folders: The primary key for a folder is “MSCC_ORG_FOLDER” “MSCC_OFFID_FOLDER” MSCC_USER” “MSCC_FOLDER” and “MSCC_ORG_OWNER”. When a folder is established, it is stored as a new row in table MSCC_FOLDER and as a new MSCC_COLLECTION; mServices Communications Center must create the new Collection beneath the sheets, on behalf of the client.

A folder will contain objects, and a folder can be shared. Instead of creating another structure for identifying and sharing folders, we use the object structure. In this case, the folder table is really just a junction table, to allow a many-to-many relationship among objects. That means that a folder can contain many objects, and an object may be included in many folders.

Take an IFTA license, for example. The same license may be used for many vehicles. In another example, we may be keeping trip records within a folder, and want to accumulate some (but not all) the records into a grouping that is shared differently.

One must carefully consider the ambiguity in the share model. For example, suppose one considers some objects within a Collection as private, but then shares the Collection within a folder. Because the folder Collection entity(ies) may have more permissive shares than the associated objects, one needs to define the security model and mServices Communications Center must enforce that model (abstract from the requesting services).

This service response will provide the MSCC_OBJECT_SEQUENCE of the added object, along with the Dropbox file link if the Requestor gave a file handle. Note that this service can be publicized as well, but any file handle that is given from an external resource (that is, not known to our secure dropbox) will be ignored and an informational message will be provided in the response (as opposed to a link). Responses include codified indications of: SUCCESS, NOT UNIQUE, NOT AUTHORIZED.

Function addCollectionToFolder

A Folder is created by adding a Collection; if the Folder doesn't exist, then a new Folder is created. This function builds a relationship between a Collection and a Folder, so the requestor must be authorized to update the folder (more precisely, the Collection). A Collection will be added to the Folder without regard to the requestor's rights to the included Collection or the associated objects, since access to objects is always determined at inquiry time. Therefore, it is possible that information will be associated with a folder that a particular user may not be able to see some, or any, of the objects in the collections.

Note that a Folder has two types of relationships with Collections. First, a Folder has a defining Collection. This defining Collection provides the metadata and shares for the Folder; this structure allows any number of “folders within folders”. The defining Collection would not typically have objects, but there is no reason that it cannot. Second, a Folder can include Collections, and Collections may be included in multiple Folders. The security model says that a requestor can include a Collection but have access to none, some, or all the objects within that Collection. Accession rights are always evaluated at the time the access is attempted.

mServices Communications Center will add the Folder, even if it turns out that the Collection that the requestor wants to include doesn't exist or if the requestor doesn't have access to any of the objects, but mServices Communications Center will deny this transaction if included Collection does not exist.

Rights to a Folder is defined in the security model as conferred from either ownership or creator of the defining Collection, the user (ORG+OFFICE+USER) owner of the Folder, a member of the office (if no user is defined for the folder), or a member of the organization (if the folder is not qualified by office or user).

The requestor provides primary key of the Folder and target Collection and Folder. If the Folder does not exist, then mServices Communications Center creates the Folder and (establishes the Collection that defines the Folder) with the user in the request as the owner and as the creator.

If validation is successful mServices Communications Center will insert a new row into table of MSCC_FOLDER_CONTENTS. Responses include codified indications of: SUCCESS, NOT ADDED (ALREADY EXISTS), NOT AUTHORIZED.

Function removeCollectionFromFolder

This function disconnects relationships between a Collection and a Folder with which it is included. The Communications Center requires that the requestor has either ownership or update permissions for the Folder, or is the owner or creator of the included Collection. The requestor provides primary keys of the Folder and the included Collection. Note that nothing is actually deleted except for the association of the included Collection from the Folder. This removal will be successful even if the requestor does not have access for all the objects within the included Collection. mServices Communications Center will deny this intent if the Folder does not exist. If the Folder exists but the Collection is not contained in the Folder, the response will indicate success anyway (to hide underlying information). Responses include codified indications of: SUCCESS, NOT AUTHORIZED.

Function deleteFolder

This function deletes folder created or permitted by the Requestor. Here, a folder is identified by metadata of MSCC_COLLECTION, MSCC_OBJECT, MSC_FOLDER. The requestor provides primary key of the MSCC_FOLDER. mServices Communications Center requires that the requestor has either ownership or permissions or the Folder, or denies the request. mServices Communications Center will report success if the Folder did not exist. If validation is successful mServices Communications Center will delete existed row of table of MSCC_FOLDER and its defining Collection and any objects and shares under the Collection. Collections that had been included within the Folder will not be disturbed. The deleted row are identified by primary key of MSCC_FOLDER passed in as parameters, primary key of MSCC_COLLECTION and MSCC_OBJECT retrieved from MSCC_FOLDER. Responses include codified indications of: SUCCESS, NOT AUTHORIZED.

Function addPermissions

This function adds permission to Collection/Folder created or permitted by Requestor. The requestor must provide primary key of MSCC_COLLECTION for identification of Collection, primary key of MSCC_USER_OFFICE for user, mandatory data of MSCC_ACTION_DESC_SENT_TO, MSCC_SENDER_PRIORITY, MSCC_ACTION_BY_TS, MSCC_RIGHTS_SENT_TO. mServices Communications Center assumes that the requestor has either ownership or permissions of Collection. mServices Communications Center will deny this intent if primary key don't exist or other mandatory data misses. If validation is successful mServices Communications Center will insert a new row into table of MSCC_SENT_TO. The values are provided by primary key of Collection and mandatory data passed in as parameters. Responses include codified indications of: SUCCESS, NOT AUTHORIZED.

Function removePermissions

This function revokes permission to Collection /Folder created or permitted by Requestor. The requestor must provide primary key of MSCC_SENT_TO for identification of permissions. mServices Communications Center assumes that the requestor has either ownership or permissions of Collection. mServices Communications Center will deny this intent if the primary key does not exist. If validation is successful mServices Communications Center will delete a row from table of MSCC_SENT_TO. Responses include codified indications of: SUCCESS, NOT AUTHORIZED.

Function addOrganization

It intends to perform create new organization. The Communications Center assumes that the requestor has the permission to perform this intent, and the requesting service must be from the named organization unless the user belongs to a privileged organization. The requestor must provide mandatory data of MSCC_ORGANIZATION stated in schema design document. mServices Communications Center will deny this intent if any mandatory data misses. If validation is successful mServices Communications Center will insert new row(s) into table of MSCC_ORGANIZATION. The values are provided by mandatory data passed in as parameters. Responses include codified indications of: SUCCESS, NOT AUTHORIZED.

Function addOffice

This function adds a new office under an organization. The Communications Center assumes that the requestor has the permission to perform this intent, and the requesting service must be from the named organization unless the user belongs to a privileged organization. An office always belongs to an organization. The requestor must provide primary keys of MSCC_ORGANIZATION to identify a performed organization. The mandatory parameters include: MSCC_OFFICE_DESC, MSCC_ADDR1, MSCC_ADDR2, MSCC_CITY, MSCC_JURISDICTION, MSCC_POSTAL, MSCC_MAIN_TEL. The Communications Center assumes that the requestor has the permission to perform this intent, and the requesting service must be from the named organization unless the user belongs to a privileged organization. If validation is successful mServices Communications Center will insert new row into table of MSCC_OFFICE. The values are provided by mandatory data passed in as parameters. Responses include codified indications of: SUCCESS, NOT AUTHORIZED.

Function addUser

This function creates a user to an organization. The Communications Center assumes that the requestor has the permission to perform this intent, and the requesting service must be from the named organization unless the user belongs to a privileged organization. The requestor must provide the primary key of MSCC_ORGANIZATION to identify a performed organization. MSCC_USER_NAME, MSCC_USER_EMAIL, MSCC_TELE_DAYTIME, MSCC_TIMEZONE are mandatory parameters. mServices Communications Center will deny this intent if any mandatory data misses or the organization does not exist. If validation is successful mServices Communications Center will insert new row into table of MSCC_USER. The values are provided by mandatory data passed in as parameters. Responses include codified indications of: SUCCESS, NOT AUTHORIZED.

Function updateOrganization

This function updates information of an organization. The Communications Center assumes that the requestor has the permission to perform this intent, and the requesting service must be from the named organization unless the user belongs to a privileged organization. The requestor must provide primary key of MSCC_ORGANIZATION to identify performed organization. The requestor must provide “new “organization data for updates. mServices Communications Center will deny this intent if organization does not exist. If validation is successful mServices Communications Center will update row of table of MSCC_ORGANIZATION. The values are provided by data passed in as parameters. Responses include codified indications of: SUCCESS, NOT AUTHORIZED

Function updateOffice

This function updates information of an office. The Communications Center assumes that the requestor has the permission to perform this function, but only users within an organization may update offices within that organization. The requestor must provide primary key of MSCC_OFFICE to identify performed office. The requestor must provide “new “office data for updates. mServices Communications Center will deny this intent if the office does not exist. If validation is successful mServices Communications Center will update row of table of MSCC_OFFICE. The values are provided by data passed in as parameters. Responses include codified indications of: SUCCESS, NOT AUTHORIZED.

Function updateUser

This function updates information of user. The Communications Center assumes that the requestor has the permission to perform this intent, and the requesting service must be from the named organization unless the user belongs to a privileged organization. The requestor must provide primary key of MSCC_USER to identify performed user. The requestor must provide “new “user data for updates. mServices Communications Center will deny this intent if user does not exist. If validation is successful mServices Communications Center will update row of table of MSCC_USER. The values are provided by data passed in as parameters. Responses include codified indications of: SUCCESS, NOT AUTHORIZED.

Function removeOrganization

This function deletes an organization. The Communications Center assumes that the requestor has the permission to perform this intent, and the requesting service must be from the named organization unless the user belongs to a privileged organization. The requestor must provide the primary key of MSCC_ORGANIZATION to identify the performed organization. But mServices Communications Center will deny this intent if organization doesn't exist. If validation is successful mServices Communications Center will delete row of table of MSCC_ORGANIZATION. The values are provided by data passed in as parameters. Responses include codified indications of: SUCCESS, NOT AUTHORIZED.

Function removeOffice

This function deletes an office. The Communications Center assumes that the requestor has the permission to perform this intent, and the requesting service must be from the named organization unless the user belongs to a privileged organization. The requestor must provide primary key of MSCC_OFFICE to identify performed office. But mServices Communications Center will deny this intent if office doesn't exist. If validation is successful mServices Communications Center will delete row from table of MSCC OFFICE. The values are provided by data passed in as parameters. Responses include codified indications of: SUCCESS, NOT AUTHORIZED.

Function removeUser

This function deletes a user. The Communications Center assumes that the requestor has the permission to perform this intent, and the requesting service must be from the named organization unless the user belongs to a privileged organization. The requestor must provide primary key of MSCC_USER to identify performed user. The Communications Center will deny this intent if user doesn't exist. If validation is successful mServices Communications Center will delete row from table of MSCC_USER. The values are provided by data passed in as parameters. Responses include codified indications of: SUCCESS, NOT AUTHORIZED.

Function userToOffice

This function allows an application to build or remove a relationship between a user and office explicitly. The Communications Center assumes that the requestor has the permission to perform this intent, and the requesting service must be from the named organization unless the user belongs to a privileged organization. The requestor must provide primary key of MSCC_OFFICE to identify performed office as well as primary key of MSCC_USER to identify performed user. mServices Communications Center will deny this intent if office or user doesn't exist. If validation is successful mServices Communications Center will insert row into table of MSCC_USER_OFFICE. The values are provided by data passed in as parameters. Responses include codified indications of: SUCCESS, NOT AUTHORIZED.

There are several functions that allow a participating application to search for data objects, and provide participating applications the data and links to the data that meet the search criteria.

Function searchObjectsByMetadata

Query by a wide range of metadata at the object level; will return up to a configurable limit, such as 100, object links. Zero returned links indicates no objects were found.

Function getObjectsByKey

Query by the exact key (that is, one sequence). Requestor may ask for objects tied to a Collection, using the primary key of the Collection. Queries may typically be used to either: (i) Obtain one Collection (and its collection of objects) for processing; (ii) Obtain one Collections, for use/information/approval, or processing; or (iii) Obtain two Collections, usually to relay as an eCredential to an outside user. One of the two objects will likely include information (content within the structured data and/or objects) that describe the context of the other object. For example, if the requestor were to send an invoice, then one of the objects may be the invoice and another may be the generalized instructions regarding payment options. Another example may be IRP renewal, where one of the Collections include the inserts, instructions, and forms, while the other object includes the variety of account/fleet-specific information. The request will include a first and last sequence number. The response is limited to a configurable maximum number of objects, such as 50, so the application is encouraged to scroll for a “page” worth of objects at a time. A response will include information for up to a configurable limit, such as 50, objects, if the Collection is found. Responses include codified indications of: SUCCESS, NOT AUTHORIZED.

Function getObjectsByReference

Query by the reference key. This query includes switches to return only the exact reference (that is, one sequence) or a range of links starting at a sequence number. A configurable maximum number of links, such as 100, will be returned, and only those objects to which the requestor is permitted will be returned. Responses include codified indications of: SUCCESS, NOT AUTHORIZED.

Function getObjectsByCollection

This duplicates functionality in getObjectsByReference, for a folder, and is provided for convenience to application programs. Responses include codified indications of: SUCCESS, NOT AUTHORIZED.

Function getCollectionsInFolder

Returns the keys to the collections included within a folder (up to a configurable maximum). Responses include codified indications of: SUCCESS, NOT AUTHORIZED.

Function updateObject

This function updates information of Object. The Communications Center assumes that the requestor has the permission to perform this intent, and the requesting service must be from the named organization unless the user belongs to a privileged organization. The requestor must provide primary key of MSCC_COLLECTION to identify performed Object. The requestor must provide “new “Object data for updates. mServices Communications Center will deny this intent if Object does not exist. If validation is successful mServices Communications Center will update row of table of MSCC_OBJECT. The values are provided by data passed in as parameters. Responses include codified indications of: SUCCESS, NOT AUTHORIZED.

There are functions to “deliver” data, which involve either sending a link to the archive, such as by electronic mail with internet-accessible information, or by rendering the data into a form for printing, faxing, or paper (or other form, for mailing).

Function emailObjects

mServices Communications Center will use its SMTP site to email objects, according to the email address(es) provided by the requestor. The email contents will be only the primary key information and the following attributes: (i) MSCC_ISSUING_JURE; (ii) MSCC_PROGRAM; (iii) MSCC_CUSTOMER_ID; (iv) MSCC_TIME_CREATED; (v) MSCC_CREATION_METHOD; (vi) MSCC_ACQ_USER_OR_SERVICE; (vii) MSCC_TIME_INGESTED; and (viii) MSCC_INGEST_METHOD. mServices Communications Center will create Contents based on information provided by requestor. Responses include codified indications of: SUCCESS, NOT AUTHORIZED.

Function printObjects

This function invokes internet-defined end devices that render the object as a printed or scanned (rasterized) object. Responses include codified indications of: SUCCESS, NOT AUTHORIZED.

Function mailObjects

This function call will allow up configurable maximum number of objects, such as 100, to be printed and mailed (from Legatus Solutions' mail service, per in-place services agreement). The function call provides mailing address information, and the mServices Communications Center will insert the “send-to” instruction as well as “sent-on” attributes when the mailing is completed. Responses include codified indications of: SUCCESS, NOT AUTHORIZED.

There are functions to assign or request actions, and these functions involve sending the links to either objects or collections with a permission or action type, such as “for information” or “for action”. Participating applications are free to establish their own assignment or action types.

Function sendAction

This function provides a “send-to” action, which may confer access rights and/or request action on an object. This function may be performed by any user that has at least read rights to the object. Any sendAction, whether to be logically interpreted as an information only or action request, confers read capabilities to the receiving entity. Responses include codified indications of: SUCCESS, NOT AUTHORIZED.

Function unsendAction

This function deletes a “send-to” action, which may confer access rights and/or request action on an object. This function may be processed by a creator or owner, as well as the user that sent the action. Responses include codified indications of: SUCCESS, NOT AUTHORIZED.

Function recordAction

This function records that an action was taken on an object; this logs all assignments (sendAction and unsendAction) and actions taken (retrievals made, approvals, etc.), including transfer of ownership or creator (i.e., facilitator). This function may be performed by an entity that has an action pending on the object; the sender, owner, or creator of the object may cancel the requested action. Responses include codified indications of: SUCCESS, NOT AUTHORIZED.

Function transferOwner

This function transfers ownership within the organization from one user/office to another user/office. This function may be processed by the Collection's creator or owner. Responses include codified indications of: SUCCESS, NOT AUTHORIZED.

Function transferCreator

This function transfers creator within the organization from one user/office to another user/office. This function may be processed by the Collection's creator or owner. Responses include codified indications of: SUCCESS, NOT AUTHORIZED. From time to time, a participating application may want to update the metadata that describes the collection or objects within a collection. There are several functions that allow a participating application to update data describing Collections and Objects.

Function updateCollectionName

It intends to perform to update information of Collection. The requestor must provide primary key of MSCC_COLLECTION to identify performed Collection. The requestor must provide “new “Collection data for updates. mServices Communications Center will deny this intent if Collection does not exist. If validation is successful mServices Communications Center will update row of table of MSCC_COLLECTION. The values are provided by data passed in as parameters. Responses include codified indications of: SUCCESS, NOT AUTHORIZED.

Function updateObject

This function updates information of an object, to include the metadata and/or the actual object file. If a new object file is stored, then the back-end archive repository will note the original and the replacing object.

Turning back to FIG. 2, which depicts an example of the Communications Center database structure; this figure describes the database “key” data and table relationships. This detail demonstrates how the data from Communication Center functions will be stored within a persistent data store.

The Communications Center cooperates with other data structures and functions that permit a participating program to look up reference information from other data sources, based on the metadata in objects. In one example, the service functions allow a program to query information about a vehicle using the Vehicle Identification Number (VIN) or Plate Number, based on Jurisdiction information (alone or as aggregated by, for example, the Federal Motor Carrier Administration). That a participating program can look up a VIN is not unique, as there are many systems that allow that, but an open system that allows a participating application to store the actual registration card, for example, and display that data object, is unique to the Communications Center.

It is in this feature that key value to the Communication Center is inferred. In one example, the registration of an interstate motor carrier vehicle (truck power unit) that is properly registered by an authorized jurisdiction for interstate traveling, such as under the International Registration Plan (IRP), will not be propagated through the United States systems view the federally-defined Commercial Vehicle Information Exchange Window (CVIEW) capability, for one or more days. Using the Communications Center, an authorized organization may post the registration and the image of the registration card real time; this closes a significant time-hole in the federal and inter-jurisdictional systems may be relied upon by over 19,000 governmental agencies.

The same capability allows better coordination between the industry participants and the “base” jurisdictions that license and register aspects of the transportation community. Using the Communications Center, vehicle registrants may easily store their distance records, maintenance reports, fuel receipts, drivers' logs, cargo manifests, and so on, to support distance and fuel reporting under IRP and the International Fuel Tax Agreement (IFTA). This ability actually delivers multiple key benefits, by facilitating the registration and license renewal processes and underlying data summaries, enabling the motor carrier to institute, track, and report internal controls, and report the summaries and details to jurisdictions as are required by multiple programs.

Add and Remove Functions

Function makeNewCollection

Description: As an application level user (mCarrier, mRecords or 3rd party Apps), it can request this service to create a specified object collection in the repository of mServices communication center which represents a folder or descriptor of single or multiple objects of MSCC. It is a logic model.

Main Aspects: If MSCC_REF_NBR is null, then create a unique value by pre-defined rules. If found any record exists with composite primary key, then NOT UNIQUE is returned. If MSCC_DIALOG_SHARE is null, then default permission (protect) is assigned. The available values are: private, public, protect. If office ID does not yet exist (within the organization), a new office will be created. If a folder does not yet exist (within the organization), a new folder will be created. If a user does not yet exist (within the organization), a new user will be created, and user will be added to the office if office exists. If the creator (owner proxy) does not exist in the same namespace as owner, then the transaction will be rejected (NOT AUTHORIZED). If the user does not exist in the same namespace as office if office exists, then reject. If responded requested collection exists, then build relationship between them. If success in creating the new collection, MSCC_HALFALOGUE_START_TS will be assigned of value of the current timestamp. Responses include codified indications of: SUCCESS, NOT UNIQUE, NOT AUTHORIZED.

Validations: Unique collection; and Permission in among owner, creator, office, user.

Related Class: MsccCollection; MsccOffice; MsccOrganization; MsccUser; MsccFolder; MsccFolderContents; MsCodeTable; and MsccLog.

Function addNewObjectFromFileHandle

Description: As an application level user (mCarrier, mRecord or 3rd party Apps), it can request this service to add content to an assigned collection. The collection is a header; detail information is being provided in MCC_OBJECT entries. There may be several objects associated with a Collection—each new object will be saved via a separate call. For example, if the requestor wants to save 10 documents for one collection (maybe 10 trip reports), then there will be one makeNewCollection and at least 10 addNewObjectFromFileHandle calls. Requestor must provide key elements of owning collection. Requestor can specify object path, which is currently managed by Dropbox. MSCC_OBJECT_HANDLE represents a physical location of an object. MSCC_OBJECT_LINK represents a logical, distribution able (shareable) entity of an object.

Main Aspects: MSCC_OBJECT_SEQUENCE is always null/0/empty, MSCC creates an ordered, unique integer value by pre-defined rules and assign the value to it within the same containing collection. An object inherits permission from its containing collection. Non static metadatas are store in MSCC_Meta. MSCC_OBJECT_MD5 is a digital signature of an object(Future). If MSCC_OBJECT_HANDLE exists, MSCC will generate a Dropbox share link ONLY after the handle has been synced to dropbox already. Responses include codified indications of: SUCCESS, NOT UNIQUE, NOT AUTHORIZED.

Validations: Unique object.

Related Class: MsccObject; MsccCollection; MsCodeTable; and MsccLog.

Function addFolder

Description: As an application level user (mCarrier, mRecords or 3rd party Apps), it can request this service to create a folder in the repository of mServices communication center which represents a folder, which can comprise single or multiple collection(s) or folder(s). It is not only a logic model but also a physical model. Both MSCC_FOLDER and MSCC_COLLECTION are put together to represent a logical folder. Table of MSCC_OBJECT are physical representation of a folder, not implemented.

Main Aspects: Information for a collection must be passed in and validated. Information describing a folder must be passed in and validated. An object must be created to represent physical location of the folder*. The default permission for a folder is protect. Responses include codified indications of: SUCCESS, NOT UNIQUE, NOT AUTHORIZED. Currently, to implement by calling function of makeNewCollection.

Validations: Unique collection; Unique folder.

Related Class: MsccCollection; MsccObject; MsccFolder; MsCodeTable; MsccLog.

Note about folders: The primary key for a folder is “MSCC_ORG_FOLDER”; “MSCC_OFFID_FOLDER”; MSCC_USER”; “MSCC_FOLDER”; and “MSCC_ORG_OWNER”. When a folder is established, it is stored as a new row in table MSCC_FOLDER and as a new MSCC_COLLECTION; mServices Communications Center must create the new Collection beneath the sheets, on behalf of the client.

A folder will contain objects, and a folder can be shared. Instead of creating another structure for identifying and sharing folders, we use the object structure. In this case, the folder table is really just a junction table, to allow a many-to-many relationship among objects. This means that a folder can contain many objects, and an object may be included in many folders, to encourage and allow cross-referencing and sharing information whose provenance is ascertained.

The reason to do so is this. Take an IFTA license, for example. The same license may be used for many vehicles. In another example, we may be keeping trip records within a folder, and want to accumulate some (but not all) the records into a grouping that is shared differently. One needs to carefully consider the ambiguity in the share model. For example, supposed one consider some objects within a Collection as private, but then we share the Collection within a folder. Because the folder Collection entity(ies) may have more permissive shares than the associated objects, we need to define the security model and mServices Communications Center must enforce that model (abstract from the requesting services).

Function addCollectionToFolder

Description: As an application level user (mCarrier, mRecords or 3rd party Apps), it can request this service to add a collection of the repository of mServices communication center to target folder. The “Add” is actually just adding the reference of collection if both namespace of collection and namespace of user are the same, otherwise it is a “Copy”, which mean a “clone”. By above action, we can eliminate the ambiguity of ownership between collection and objects in is containing. This function builds a relationship between a Collection and a Folder, so the requestor must be authorized to update the folder (more precisely, the Collection). A Collection will be added to the Folder without regard to the requestor's rights to the included Collection or the associated objects, since access to objects is always determined at inquiry time. Therefore, it is possible that information will be associated with a folder that a particular user may not be able to see some, or any, of the objects in the collections.

Main Aspects: It is very important to verify if the collection is allowed to be added by the user. If collection exists in the folder, then no need to add one more time. If success in this adding, MSCC will create a relationship in table of MSCC_FOLDER_CONTENTS. Responses include codified indications of: SUCCESS, NOT UNIQUE, NOT AUTHORIZED.

Validations: Unique collection in folder.

Related Data: MsccCollection; MsccFolder; MsccFolderContents; MsCodeTable; and MsccLog.

Note that a Folder has two types of relationships with Collections. First, a Folder has a defining Collection. This defining Collection provides the metadata and shares for the Folder; this structure allows any number of “folders within folders”. The defining Collection would not typically have objects, but there is no reason that it cannot. Second, a Folder can include Collections, and Collections may be included in multiple Folders. The security model says that a requestor can include a Collection but have access to none, some, or all the objects within that Collection. Accession rights are always evaluated at the time the access is attempted.

mServices Communications Center will add the Folder, even if it turns out that the Collection that the requestor wants to include doesn't exist or if the requestor doesn't have access to any of the objects, but mServices Communications Center will deny this transaction if included Collection does not exist.

Rights to a Folder is defined in the security model as conferred from either ownership or creator of the defining Collection, the user (ORG+OFFICE+USER) owner of the Folder, a member of the office (if no user is defined for the folder), or a member of the organization (if the folder is not qualified by office or user).

Function removeCollectionFromFolder

Description: As an application level user (mCarrier, mRecords or 3rd party Apps), it can request this service to remove a collection of the repository of mServices communication center from target folder. The “Remove” is actually just remove the reference or connection, the collection itself still exists, no matter it is original or cloned. This removal will be successful even if the requestor does not have access for all the objects within the included Collection.

Main Aspects: Validate the permission of collection and folder. As simple as deleting a row from MSCC_FOLDER_CONTENTS. Responses include codified indications of: SUCCESS, NOT UNIQUE, NOT AUTHORIZED.

Validations: Both folder and collection exists.

Related Class: MsccCollection; MsccFolder; MsccFolderContents; MsCodeTable; and MsccLog.

Function deleteFolder

Description: As an application level user (mCarrier, mRecords or 3rd party Apps), it can request this service to delete a folder from the repository of mServices communication center. First of all, the deletion will delete both logical and physical representation of a folder. Any entities are comprised inside this folder are still available after folder removing. This removal will be successful even if the requestor does not have access for all the objects(collections) within the included folder.

Main Aspects: Responses include codified indications of: SUCCESS, NOT UNIQUE, NOT AUTHORIZED.

Validations: Existence of the folder.

Related Class: MsccFolder; MsccCollection; MsCodeTable; and MsccLog.

Function addPermissions

Description: As an application level user (mCarrier, mRecords or 3rd party Apps), it can request this service to add permissions to a target entity repository of mServices communication center. The permission of an entity represents accessibility of an entity for current design. We can call it ACL (access control list) based permission instead of RBA based permission. Accessibility includes: [public]—full control; [private]—only available to active owner and creator; [protect]—automatically is granted permission among the same level of party, for example, “Organization Lobby”, “Office Lobby”. ASORGSEND—force to be shared within an organization. ASOFFICESEND—force to be shared only within an office below an organization. ASUSERSEND—force to be shared to specific user only. The default permission level is “protect”. This function also can control the depth of entity to be permitted. We can only add a permission to entity corresponding to an existed “user”. For example, we cannot add “ASOFFICESEND” to a non-existed OFFID, ASUSER to a non-existed user or “ASOFFICESEND” to an organization or a user. The permitted entity is an object only when OBJECT_SEQUENCE is not null(greater than 0). By definition of table MSCC_SENT_TO, permission is able to cross organization and office.

Main Aspects: We need to confirm if the grantee has no permission to this collection/object. Certainly, grantor must have permission to this collection/object. Grantor cannot grant a non-exist collection/object. The collection can be a folder.

Validations: Existence of collection/object. Permission to target collection/object. Non-exist of permissions to the target collection/object.

Related Class: MsccCollection; MsccObject; MsccOwnerIdentity; MsccUserIdentity; MsccSentTo; MsCodeTable; and MsccLog.

Function removePermissions

Description: As an application level user (mCarrier, mRecords or 3rd party Apps), it can request this service to revoke a permission to a target entity repository of mServices communication center. The permission of an entity represents accessibility of an entity for current design. We can call it ACL (access control list) based permission instead of RBA based permission. Accessibility includes: [public]—full control; [private]—only available to active owner and creator; [protect]—automatically is granted permission among the same level of party, for example, “Organization Lobby”, “Office Lobby”; [share]—is private before it is granted to another grantee; ASORGSEND—force to be shared within an organization; ASOFFICESEND—force to be shared only within an office below an organization; and ASUSERSEND—force to be shared to specific user only. The default permission level is protect.

Main Aspects: The permission must exist before it can be revoked. If grantor is being deleted or the grantor no long owns the permission to this entity, the permission cannot be revoked any more.

Validations: The existence of the Grantor. The existence of collection/object. The existence of permission to this collection/object.

Related Data: MsccCollection; MsccObject; MsccOwnerIdentity; MsccUserIdentity; MsCodeTable; and MsccLog.

Function addOrganization

Description: As an application level user (mCarrier, mRecords or 3rd party Apps), it can request this service to add an organization to entity repository of mServices communication center. The organization is the most foundation entity of mServices communication center. All other entity cannot exist without belonging to one organization. It represents a logical unit as well a physical location.

Main Aspects: Make sure the organization unique. Responses include codified indications of: SUCCESS, NOT UNIQUE, NOT AUTHORIZED.

Validations: Unique.

Related Class: MsccOrganization; and MsCodeTable.

Function addOffice

Generic Description: As an application level user (mCarrier, mRecords or 3rd party Apps), it can request this service to add an office to entity repository of mServices communication center. It represents a logical unit as well a physical location. The office cannot exist without an organization.

Main Aspects: Make sure the office unique. Make sure organization existing before an office. Responses include codified indications of: SUCCESS, NOT UNIQUE, NOT AUTHORIZED.

Validations: Unique.

Related Class: MsccOrganization; MsccOffice; and MsCodeTable.

Function add User

Description: As an application level user (mCarrier, mRecords or 3rd party Apps), it can request this service to add a user to entity repository of mServices communication center. It represents a logical unit as well a physical person. The user cannot exist without an organization. The user can belong to a single or multiple office.

Main Aspects: Validate the existence of organization, office, user. All of them must compliance the namespace. Responses include codified indications of: SUCCESS, NOT UNIQUE, NOT AUTHORIZED.

Validations: Unique of Organization; Unique of user and Both Office and user belong the same organization.

Related Class: MsccOrganization; MsccOffice; MsccUserOffice; and MsCodeTable.

Function updateOrganization

Description: As an application level user (mCarrier, mRecords or 3rd party Apps), it can request this service to update information of an organization of repository of mServices communication center. Update information of an organization. The requestor must provide “new “office data for updates.

Main Aspects: An organization information can be updated only if the organization exists already. Responses include codified indications of: SUCCESS, NOT UNIQUE, NOT AUTHORIZED.

Validations: Unique organization; and Organization exists.

Related Class: MsccOrganization; and MsCodeTable.

Function updateOffice

Description: As an application level user (mCarrier, mRecords or 3rd party Apps), it can request this service to update information of an office to entity repository of mServices communication center. It represents a logical unit as well a physical location. The office cannot exist without an organization. The requestor must provide “new “office data for updates.

Main Aspects: Validate the existence of office. Validate if organization exists. The same office can not belong to different organization. Responses include codified indications of: SUCCESS, NOT UNIQUE, NOT AUTHORIZED.

Validations: Existence of organization ; and Existence of office.

Related Class: MsccOrganization; MsccOffice; and MsCodeTable.

Function update User

Description: As an application level user (mCarrier, mRecords or 3rd party Apps), it can request this service to update information of a user entity repository of mServices communication center. It represents a logical unit as well a physical person. The user cannot exist without an organization. The user can belong to a single or multiple office.

Main Aspects: Validate the existence of organization, office, user. The user cannot cross organization. Responses include codified indications of: SUCCESS, NOT UNIQUE, NOT AUTHORIZED.

Validations: Organization, office, user must exist in the same namespace. Unique user in organization.

Related Class: MsccOrganization; MsccOffice; MsccUser; MsccUserOffice; and MsCodeTable.

Function removeOrganization

Description: As an application level user (mCarrier, mRecords or 3rd party Apps), it can request this service to delete an organization of repository of mServices communication center. The organization is the most foundation entity of mServices communication center. All other entity has to belong to at least one organization. It represents a logical unit as well a physical location. Even though a user can be deleted but all the objects/collection associated with this user are still available. The permission is also being taken account.

Main Aspects: Before an organization can be deleted it has to exist in MSCC. Responses include codified indications of: SUCCESS, NOT UNIQUE, NOT AUTHORIZED.

Validations: Existence of organization; and Unique organization.

Related Class: MsccOrganization; and MsCodeTable.

Function removeOffice

Description: As an application level user (mCarrier, mRecords or 3rd party Apps), it can request this service to delete an office entity repository of mServices communication center. It represents a logical unit as well a physical location. The office cannot exist without an organization.Even though a user can be deleted but all the objects/collection associated with this user are still available. The permission is also being taken account.

Main Aspects: Only remove an existing office. User is still available even office is removed. Responses include codified indications of: SUCCESS, NOT UNIQUE, NOT AUTHORIZED.

Validations: Unique office; and Existence of office.

Related Data: MsccOffice; and MsCodeTable.

Function remove User

Description: As an application level user (mCarrier, mRecords or 3rd party Apps), it can request this service to delete a user entity repository of mServices communication center.It represents a logical unit as well a physical person. The user cannot exist without an organization. The user can belong to a single or multiple office. The Communications Center will deny this intent if user does not exist.

Main Aspects: If a user is deleted, MsccUserOffice table is also been updated if the user belongs to the certain office. Even though a user can be deleted but all the objects/collection associated with this user are still available. The permission is also being taken account. Responses include codified indications of: SUCCESS, NOT UNIQUE, NOT AUTHORIZED.

Validations: Existence of the user; and Existence of UserToOffice.

Related Class: MsccUser; MsccUserOffice; and MsCodeTable.

Function userToOffice

Description: As an application level user (mCarrier, mRecords or 3rd party Apps), it can request this service to add a relationship between a user and office explicitly. It represents a logical relationship between an office and a user. The user cannot exist without an organization. The user can belong to a single or multiple office. The Communications Center will deny this intent if user or office does not exist. A facilitator can be created by calling this service.

Main Aspects: The user and office must exist before this intent can be performed. The user and office must exist in the same organization. The entity here can represent a facilitator for anther organization, office, user if the corresponding information is provided. Responses include codified indications of: SUCCESS, NOT UNIQUE, NOT AUTHORIZED.

Validations: The existence user, office, organization. The unique of user, office, organization. The same namespace of user, office, organization. The existence of served user, office, organization if user in this office is a facilitator.

Related Class: MsccOrganization; MsccOffice; MsccUserToOffice; and MsCodeTable.

Find Functions

There are several functions that allow a participating application to search for data objects.

Function search ObjectsByMetadata

Description: As an application level user (mCarrier, mRecords or 3rd party Apps), it can request this service to retrieve objects based on metadata passed in. Collection/folder and object are the selective search entity: Multiple entities; and Cross entity boundary. The user can only search objects he owns the accessibility. Query by a wide range of metadata at the object/collection/folder level. Query criteria is defined by the searcher. Preferred format is defined by the searcher.

Main Aspects: The user has to define the query criteria passed in. All the dynamic metadata are defined in the table MSCC_META. The objects cannot be returned if the user has no accessibility to it. If success in search, MSCC will return a list of objects. The implicit entity is object.

Validations: Permission has to be validated. Existence of metadata passed in. All the metadata must be on objects level only.

Related Class: MsccCollection; MsccObject; MsccFolder; MsccQueryCriteria; MsccSentTo; MsccLog; and MsCodeTable.

Function getObjectsByKey

Description: As an application level user (mCarrier, mRecords or 3rd party Apps), it can request this service to retrieve objects based on “key” passed in. Also need to make sure the accessibility of returned objects.

Main Aspects: No object will be returned if the user has no accessibility to it. In most cases, only one key is passed, but list of key is ok. If success in search, MSCC will look up MSCC_OBJECT and find the objects.

Validations: Permission has to be validated.

Related Class: MsccObject; MsccIdentity; MsccLog; and MsCodeTable. Query by the exact key (that is, one sequence). Requestor may ask for objects tied to a Collection, using the primary key of the Collection. Queries may typically be used to either: (i) Obtain one Collection (and its collection of objects) for processing; (ii) Obtain one Collections, for use/information/approval, or processing; or (iii) Obtain two Collections, usually to relay as an eCredential to an outside user. One of the two objects will likely include information (content within the structured data and/or objects) that describes the context of the other object. For example, if the requestor were to send an invoice, then one of the objects may be the invoice and another may be the generalized instructions regarding payment options. Another example may be IRP renewal, where one of the Collections includes the inserts, instructions, and forms, while the other object includes the variety of account/fleet-specific information.

The request will include a first and last sequence number. The response is limited to 50 objects, so the application is encouraged to scroll for a “page” worth of objects at a time. A response will include information for up to 50 objects, if the Collection is found. Responses include codified indications of: SUCCESS, NOT AUTHORIZED.

Function getObjectsByReference

Description: As an application level user (mCarrier, mRecords or 3rd party Apps), it can request this service to retrieve objects based on reference passed in. Collection and folder are the selective search entity: Multiple entities and Cross entity boundary. Also need to make sure the accessibility of returned objects. Query by a wide range of metadata at the object level. It also controls the query criteria.

Main Aspects: The user has to define the query criteria passed in. All the dynamic metadata are defined in the table MSCC_META. The objects cannot be returned if the user has no accessibility to it. If success in search, MSCC will return a list of objects. The reference can be a list of reference. The implicit entity is collection and folder.

Validations: Permission has to be validated. Existence of metadata passed in. All the metadata must be on objects level only.

Related Class: MsccObject; MsccQueryCriteria; MsccLog; and MsCodeTable

Function getObjectsByCollection

Description: As an application level user (mCarrier, mRecords or 3rd party Apps), it can request this service to retrieve objects based on “reference” passed in. Collection and folder are the selective search entity: Multiple entities; and Cross entity boundary. Also need to make sure the accessibility of returned objects. Query by a wide range at the object level. It also controls the query criteria.

| Parameter | Description |
|---|---|
| CollectionID | Defined by an owning organization, optionally office and |
| | user, and a reference number, the collection is a set |
| | of objects and data that belong together to elaborate a |
| | credential, document, function, request, and or answers |
| | to the business transaction. |

Main Aspects: The user has to define the query criteria passed in. The objects cannot be returned if the user has no accessibility to it. If success in search, MSCC will return a list of objects.

Validations: Existence of collection.

Related Class: MsccCollection; MsccObject; MsccLog; and MsCodeTable.

Function getCollectionsInFolder

Description: As an application level user (mCarrier, mRecords or 3rd party Apps), it can request this service to retrieve objects based on “reference” passed in. Collection and folder are the selective search entity: Multiple entities; and Cross entity boundary. Also need to make sure the accessibility of returned collections. Query by a wide range at the collection level. It also controls the query criteria.

| Parameter | Description |
|---|---|
| FolderID | Defined in the same manner as a collection, a folder allows |
| | the sharing of collection data so that it may be accessed |
| | and viewed in the appropriate and different perspectives, |
| | while the linked-to collection data keeps its original |
| | provenance. |

Main Aspects: The user has to define the query criteria passed in. The collections cannot be returned if the user has no accessibility to it. If success in search, MSCC will return a list of collections. The implicit entity is collection and folder.

Validations: Permission has to be validated. Existence of folder passed in.

Related Class: MsccCollection; MsccFolder; MsccQueryCriteria; MsccIdentity; MsccLog; and MsCodeTable.

Function listFolder

Description: As an application level user (mCarrier, mRecords or 3rd party Apps), it can request this service to list current available folders. Replaced by getCollectionInFolder.

Deliver Functions

The functions to “deliver” data involves either sending a link to the archive, such as by electronic mail with Internet-accessible information, or by rendering the data into a form for printing, faxing, or paper (or other form, for mailing).

Function emailObjects

Description: As an application level user (mCarrier, mRecords or 3rd party Apps), it can request this service to use MSCC's SMTP site to email objects, according to the email address(es) provided by the requestor. The MSCC core server will make sure the accessibility of objects. It also controls the mail criteria. It can define content message template. MSCC has no control over objects that have already been delivered; the application level user can redistribute the data object, though the recipient of those “copies” does not have the same assurance provided by MSCC directly. In this way, application level uses are encouraged to provide a linkage to the MSCC object rather than—like todays “electronic credentials”—provide copies that can be altered.

Main Aspects: The MsccEmailFact has to be filled before the email can be sent out. Mscc provide a default template for email message. Mscc only can email authorized object. If success in search, MSCC will look up MSCC_OBJECT and find the objects.

Validations: MsccEmailFact must be filled. Existence of objects.Permission to each objects.

Related Class: MsccObject; MsccEmailFact; and MsccIdentity.

Function printObjects

Description: As an application level user (mCarrier, mRecords or 3rd party Apps), it can request this service to use MSCC's defined cloud based printer to render the object as a printed or scanned (rasterized) object. Also need to make sure the accessibility of objects.It also controls the print criteria. It can define content message template.

Main Aspects: Validate the accessibility. If success in search, MSCC will return a list of objects.

Validations: The MsccPrintFact has to be filled before the object can be printed. Mscc provide a default template for printing. Mscc only can print authorized printable object. If success in search, MSCC will generate a TS to caller.

Related Data: MsccObject; MsccPrintFact; MsccIdentity;

Function mailObjects

This function call will allow up to a configurable limit, such as 10, objects to be printed and mailed (from Legatus Solutions' mail service, per in-place services agreement). The function call provides mailing address information, and the mServices Communications Center will insert the “send-to” instruction as well as “sent-on” attributes when the mailing is completed. Responses include codified indications of: SUCCESS, NOT AUTHORIZED.

Permissions and Actions Functions

Function sendAction

Description: As an application level user (mCarrier, mRecords or 3rd party Apps), it can request this service to provide a “send-to” action, which may confer access rights and/or request action on an object. This function may be performed by any user that has at least read rights to the object. It is an authorization. “S sent-to” access rights & “sent-to” actions which may be mapped in a simple application diagram, as in the chart below:

| | | | | | |
|---|---|---|---|---|---|
| Read | | Ap- | Rejec- | | |
| Only | Request | proval | tion | Update | Delete |

REVIEW AND
APPROVE
INFORMATION
TAKE OVER
OWNERSHIP
RESUBMIT
SUBMIT
REVIEW AND
COMMENT
PROCESS

Each “sent-to” has priority, expiration, etc. Also MSCC will validate the grantor's accessibility of objects.

Main Aspects: MSCC would not allow repeated action. The action can expire naturally. Certainly, grantor must have permission to this collection/object. Grantor cannot grant a non-exist collection/object. The collection can be a folder.

Validations: Existence of collection/object; Permission to target collection/object; and Non-exist of permissions to the target collection/object.

Related Class: MsccCollection; MsccObject; MsccIdentity; MsccSentTo; MsCodeTable; and MsccLog.

Function unsendAction

Description: As an application level user (mCarrier, mRecords or 3rd party Apps), it can request this service to delete a “send-to” action, which may confer access rights and/or request action on an object. This function may be performed by any user that has at least read rights to the object. It is an authorization. Each “sent-to” has priority, expiration, etc. Also MSCC will validate the grantor's accessibility of objects which may be mapped in a simple application diagram, as:

| | | | | | |
|---|---|---|---|---|---|
| Read | | Ap- | Rejec- | | |
| Only | Request | proval | tion | Update | Delete |

REVIEW AND
APPROVE
INFORMATION
TAKE OVER
OWNERSHIP
RESUBMIT
SUBMIT
REVIEW AND
COMMENT
PROCESS

Main Aspects: We need to confirm if the grantee has been sent this action. Only grantor can revoke this action. Grantor cannot grant a non-exist collection/object. The collection can be a folder.

Validations: Existence of collection/object; Action to target collection/object; and Non-exist of actions to the target collection/object.

Related Class: MsccCollection; MsccObject; MsccIdentity; MsccSentTo; MsCodeTable; and MsccLog.

Function recordAction

Description: As an application level user (mCarrier, mRecords or 3rd party Apps), it can request this service to records that an action was taken on an object; this logs all assignments (sendAction and unsendAction) and actions taken (retrievals made, approvals, etc.), including transfer of ownership or creator (i.e., facilitator). This function may be performed by an entity that has an action pending on the object; the sender, owner, or creator of the object may cancel the requested action.

Main Aspects: Only grantee can record this action. Grantee can make a new collection associated with objects to response this action and record it. The grantee can also just record “message”. Application will be blindly log the action user asked for. If success in search, MSCC will return a list of objects.

Validations: Existence of action; Existence of grantee; and Existence of grantor.

Related Class: MsccCollection; MsccObject; MsccSentTo; MsccActionTaken; MsccIdentity; MsccLog; and MsCodeTable.

Function transferOwner

Description: As an application level user (mCarrier, mRecords or 3rd party Apps), it can request this service to transfer ownership within the organization from one user/office to another user/office.

Main Aspects: Use sendAction and takeAction to perform it. If success in search, MSCC return a TS.

Validations: Existence of user; Existence of collection or object; and Existence of owner.

Related Class: MsccCollection; MsccObject; MsccIdentity; MsccLog; and MsCodeTable.

Function transferCreator

Description: As an application level user (mCarrier, mRecords or 3rd party Apps), it can request this service to transfer creator within the organization from one user/office to another user/office.

Main Aspects: Use sendAction and takeAction to perform it. If success in search, MSCC will return a TS.

Validations: Existence of user; Existence of collection or object; and Existence of owner.

Related Class: MsccCollection; MsccObject; MsccIdentity; MsccLog; and MsCodeTable.

Update Metadata

There are several functions that allow a participating application to update data describing Collections and Objects.

Function updateCollection

Generic Description: As an application level user (mCarrier, mRecords or 3rd party Apps), it can request this service to perform to update metadata information of Collection.

Main Aspects: Validate the accessibility. If no suitable metadata for the specific collection, no any updates. The old metadata cannot be removed but can be updated. New metadata can also be set. If success in search, MSCC will return a TS.

Validations: Existence of collection; Existence of metadata; and Existence of permission to collections.

Related Class: MsccCollection; MsccMetadata; and MsccIdentity.

Function updateObject

Generic Description: As an application level user (mCarrier, mRecords or 3rd party Apps), it can request this service to perform to update information of an object, to include the metadata and/or the actual object file. If a new object file is stored, then the back-end archive repository will note the original and the replacing object.

Main Aspects: Validate the accessibility. If no suitable metadata for the specific collection, no any updates. The old metadata cannot be removed but can be updated. New metadata can also be set. If success in search, MSCC will return a TS.

Validations: Existence of collection; Existence of metadata; and Existence of permission to collections.

Related Class: MsccCollection; MsccMetadata; and MsccIdentity.

mServices Communications Center Users and Security

mServices Communications Center Security Concepts

mServices Communications Center security revolves around the Owner, Creator, and conferred rights to other users. In the most fundamental concept of the MSCC, MSCC will learn of an organization and create an Organization entry, then establish whether or not it can “trust” the organization via security administrative processes. Once an organization is trusted, then it will be able to add information to MSCC via an assigned token that only that organization uses.

The second level of security administration is the user. A user is always defined within an organization, and a user may be in zero or more offices within an organization. “Bill” in Organization1 is a different entity than “Bill” in Organization2, but Organization1's Bill is the same entity for any office within Organization1. As MSCC trusts the organization, the organizational application uses of MSCC are responsible for defining and approving its users.

Generally, collection and object ownership and access is defined always by organization, and sometimes by office, sometimes by user, and sometimes by user and office. A Folder, Collection, or Object item may be owned by an Organization, and freely accessible by any entity within that organization, or may be owned by an Organization's office, and freely accessible by any entity belonging to that organization's office, or tied to a specific user (qualified by office or not) so that only that user has free access to the item.

The mCarrier ecosystem acknowledges that an organization may proxy records; in mRecords, this is called a Records Facilitator. This could be a clerk or records manager within a company, or may be an agent. From an accession perspective (at the Collection level), a “creator” is granted the same rights as the owner, and there is a function to move an organization's “creator” or “owner” user from one person to another, such as when a person changes roles within an organization or when a company moves from one agent to another.

Note that the any user or user organization acknowledges that mServices Communications Center is not warranted to protect information beyond the business rules defined within this document. While data is encrypted at rest and during transport, a user may (for example) request a link to an object or set of objects; at that point, we regard the object has having been logically copied to the destination user or system and outside of the mCarrier ecosystem.

Key points on security include the following. Security model is simple in terms of who can grant access. Each Collection is owned by an organization, office, and/or user. “Owner” is either: Organization; Organization and office; or, Organization and user; unless owned by a user, anyone in the organization (or office within the org) has equal access. The creator has owner authority, but the owner can revoke the creator's access. Access authority is granted by owner at the object level (below the Collection). Some of the objects may be released, some not. In this way, a Collection (to include folder Collections) may be shared but only with the rights that the grantor has AT THE TIME THE GRANTEE accesses the object. Gives flexibility to applications, but also means that if access is granted to a user, and the user accesses the object, mServices Communications Center does not restrict object storage or usage of the object outside of mServices Communications Center. mServices Communications Center does track all accesses (in the SENT_TO table). Once access authority is granted, the grantee may pass along access at an equal or lesser grant. For example, you can give me a link and I can put it into my own folder. Just like email, you cannot subsequently revoke the access authority. Also, there is a function to revoke any grant that has not yet been exercised. Important concept difference is lookup (with mServices Communications Center functions) versus accessing by dropbox link. Once a link is shared outside of mServices Communications Center, we do not test for accession rights. This makes sense because once the cat is out of the bag, an accessor can copy/store the object.

User Authentication

Note that a user or entity does not log into mServices Communications Center directly, but that mServices Communications Center will only process transactions from a trusted application, and those applications embed public/private encrypted keys to the service calls and requests to ensure privacy.

Any application to use mServices Communications Center has to be pre-authenticated and authorized. Each application will be assigned a private key by mServices Communications Center administrators, and this key will be updated at least quarterly. Application requests will include its Organization encrypted by its private key, and mServices Communications Center will only process requests where the decrypted Organization exists within its database. mServices Communications Center service responses will encrypt the service success code with the application's private key; the application should process only decipherable responses.

Submitting applications are responsible for authenticating offices and users. Access to mServices Communications Center is only granted after a user is authenticated through applications (such as mCarrier, mRecord). mServices Communications Center will create users and offices based on calls from the authorized application. mServices Communications Center only enforces organization level, not office or user.

Resources: Folders, Collections, and Objects will be provided to an authorized application access per Organization and Office and/or User following object accession rules. mServices Communications Center is not responsible to ensure that the authorized application is properly allocating accession rights. mServices Communications Center does not monitor accession rights.

Roles: Organization is an attribute, not a role. At this point, we have no concept of an organization's administrator. Items stored at an organization level—not further qualified by office and/or user—are available to any user in that organization. It is like an open cabinet in the office building, and anyone allowed in the office building can add to, borrow, or take away items in that office building cabinet. Office is an attribute, not a role. At this point, we have no concept of an organization office's administrator. Items stored at an organization's office level—not further qualified by user—are available to any user in that organization. It is like an open cabinet in the office, and anyone allowed in the office can add to, borrow, or take away items in that office cabinet. Creator and owner users are peers from an access standpoint. A creator is a proxy for the owner. Other users are granted access outside of the item domain by a user within the domain. An item that is owned by an organization requires a request from that organization (user) to grant privileges to an outside user. For example, jurisdiction RI (Organization “RI”, Office “RIIRP”) creates a cab card and then grants read access to a registrant and/or agent: (i) RI/RIIRP can email that item; (ii) RI/RIIRP can grant (and later revoke) read access to organizations, offices, and/or users or public. Grants are provided through function sendAction and revoked via unsendAction; these calls manifest as MSCC_SENT_TO entries. A proper way for mCarrier to administer its role in this case is that the mCarrier organization (RI) should have a policy that allows the registrant, perhaps, to authorize the granting jurisdiction (that is, the mCarrier client jurisdiction) to send the cab card to a registrant's Collection and/or mark the cab card as “Public”. If the registrant does not allow the jurisdiction to mark the cab card as Public, then the registrant (because it has been granted read access to the object via a sendAction) or the jurisdiction (because it is the owner/creator of the cab card) can perform a sendAction (if the recipient is in the ecosystem) or emailObject, mailObject, or printObject. A typical method of exposing a collection to an outside user (such as roadside) is for the mCarrier or mRecords (or external/authorized application) to retrieve the keys (perhaps by using one of the search methods in mServices Communications Center, getObjectsByKey, getObjectsByReference, searchObjectsByMetadata, getCollectionsInFolder) and then emailing the links (emailObjects).

Permissions are granted at the Object level. Depending on the transaction, this may not be convenient, but we want to keep the actions at an object level. An example would be an IFTA license; an IFTA jurisdiction may create a Folder for a licensee, with ties to different Collections such as guidance documents and a license application. The application can use mServices Communications Center to establish a Folder with a guidance collection and a license application collection, or the application can just create a collection with the guidance and application objects. The actions required in the “send” function would be different: the guidance is sent for information, while the application is sent for action. The IFTA application would say that the customer can modify the application, but read-only the guidance. When an application queries, mServices Communications Center finds all possible responses and then is responsible to determine which objects the requestor (organization, office, and/or user) has access to AT THAT POINT IN TIME, and will return only those objects.

Authorization of Resource (Object): An Object is the only item level to be authorized, via the sendObject command. A user has object authorization IFF there is a valid path from the specific root/starting folder to the object or can be any starting point. If the user is blocked from accessing this object from the root, due to insufficient Permissions, then this Object is not authorized to this user. Collections per se (including a collection that defines a folder) is never exposed outside its owner/creator domain. While objects within the collection may be sent (or public), the folder itself is exposed only as defined by the organizational structure.Folders are always accessible by the owner and creator. Folders are always accessible by a member in the organization (if no office or user is defined in the collection owner or creator), or any member in the office (if an office is defined in the collection owner or creator). If an object isn't a folder then just check if both sent-to fields and primary key of Collection exist in the table MSCC_SENT_TO before MSCC_ACTION_BY_TS expires only. If doesn't exist, checks the value of column MSCC_FOLDER_SHARE if it's a folder object.

Message Formats

This section lists the request and response formats. All requests are logged in the table MSCC_LOG table. Note: All messages must include the following header information: RQST_ORG_OWNER CHAR(8) (entity requesting); RQST_OFFID_OWNER CHAR(8) (entity requesting); RQST_USER_OWNER” VARCHAR2(32) (entity requesting); RQST_REF_NBR VARCHAR2(32) (optional; entity's request reference number, may or may not be the same as an object or folder. This is used to look up the request made by an application); RQST_ORG_KEYPHRASE CHAR(32) (Phrase that is encrypted using secret key); RQST_ORG_ENCRYPTKEY CHAR(32) (Encrypted phrase); RQST_ORGANIZATION_CREATOR CHAR(8) (The creating application user will at times be different than the owner, such as when a computer system generates information on behalf of a different organization, office, and/or user); RQST_OFFICE_CREATOR CHAR(8) (Creating office identification); RQST_USER_CREATOR VARCHAR2(32) (Creating user identification); RQST_USER_CREATOR_EMAIL VARCHAR2(1024) (email address of the creating application user); RQST_USER_CREATOR_TELEPHONE VARCHAR2(32) (telephone number of the creating application user); RQST_TS TIMESTAMP (6) (definition by the application user as to when the request it made, in terms of its own view, since different application users have different concepts of time in terms of accuracy, precision, and timezone, as it also true for MSCC.)

Function addCollectionToFolder

A Folder is another type of collection. The function provides a tool for user to manage the collections. It can be associated with physical file path or not. A folder can only contain collection and other folders. Any object except representation of itself, is prohibited to be associated.

1. URL
a. https://api.mscc.solutions
b. /v1/folders/collections

2. HTTP Method

a. PUT

3. Add an existing collection to an existing folder.

4. Normal response codes:

a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccFolder: | | plain | object: | The folder |
| | mscc_org_folder | | MsccFolder | |
| | mscc_offid_folder | | | |
| | mscc_user_folder | | | |
| | mscc_folder | | | |
| | mscc_org_collection | | | |
| | mscc_offid_collection | | | |
| | mscc_user_collection | | | |
| | mscc_nbr_collection | | | |

| | | | |
|---|---|---|---|
| msccCollection | plain | object: | The collection. |
| mscc_org_owner | | MsccCollection | |
| mscc_offid_owner | | | |
| mscc_user_owner | | | |
| mscc_ref_nbr | | | |
| mscc_account_owner | | | |
| mscc_sub_account_owner | | | |
| mscc_dialog_share | | | |
| mscc_dialog_type | | | |
| msccIdentityUser | plain | object: | The |
| mscc_org_owner | | MsccIdentity | user(operator) |
| mscc_org_offid | | | |
| mscc_org_user | | | |

{
″″: “”,
}

Response Parameter:

| Parameter | Style | Type | Description |
|---|---|---|---|
| MSCC_HALFALOGUE_START_TS | plain | xsd: String | The |
| | | | timestamp |
| | | | of folder. |

{
″MSCC_HALFALOGUE_START_TS″: “201601010101010000”,
}

Function addNewObjectFromFileHandle

An object is contained by a collection at all the time. Its lifecycle cannot beyond be containing collection. The ingest source and media are various. No matter where it comes and what it is, it is stored in the repository of MSCC as an encrypt or decrypt object, which depends on the definition in the application. One accessible public cloud link plus authorization of it represents a logical resource. It is the only authorize able element by an enabled identity in MSCC. MD5 value is also been calculated and stored.

1. URL

a. https://api.mssc.solutions

b. /v1/collections/objects

2. HTTP METHOD:
a. POST

3. Add a new object.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccObjectCollection | | plain | object: MsccCollection | The containing collection. |
| | mscc_org_owner | plain | xsd: String | Identity for organization. |
| | mscc_org_offid | plain | xsd: String | Identity for office |
| | mscc_org_user | plain | xsd: String | Identity for user |
| | mscc_ref_nbr | plain | xsd: String | Reference tag. |
| | mscc_account_owner | | | |
| | mscc_sub_account_owner | | | |
| | mscc_dialog_share | | | |
| | mscc_dialog_type | | | |
| msccObject | | plain | object: MsccObject | The Identification of owner. |
| | mscc_org_owner | plain | | |
| | mscc_org_offid | plain | | |
| | mscc_org_user | plain | | |
| | mscc_ref_nbr | plain | | |
| | mscc_object_sequence | plain | xsd: integer | Assigned or allocated |
| | | | | sequence number. |
| | mscc_object_handle | plain | xsd: String | |
| | mscc_acq_user_service | plain | enum:MsccAcqMethod | Application generated file |
| | | | | path inside. |
| | mscc_time_created | | xsd: datetime | How the object was |
| | | | | received? |
| | mscc_creation_method | plain | enum: | When the object was |
| | | | Mscc_creation_method | actually created by owner, if |
| | | | | known. |
| | | plain | | How the object was |
| | | | | created, such as manually, |
| | | | | scan, email . . . , etc. |
| | mscc_time_ingested | | xsd:datetime | |
| | mscc_md5_value | | xsd: String | Date/time that the object |
| | | | | was processed by the |
| | | | | receiving application. |
| | mscc_ingest_method | | enum:MsccIngestMethod | How the object was |
| | | | | processed? |
| | mscc_object_type | | enum:MsccObjectType | If in a standardized domain, |
| | | | | the we know how to |
| | | | | process. |
| | mscc_instructions | | xsd: String | Instructions. |

| | | | |
|---|---|---|---|
| msccIdentityUser | plain | object: MsccIdentity | The operator. |

mscc_org_owner
mscc_org_offid
mscc_org_user

{
″″: “”,
}

7. Response Parameter:

| Parameter | Style | Type | Description |
|---|---|---|---|
| Sequence | plain | xsd: Integer | The sequence # in containing |
| | | | collection. Starts from 1. |

{
″sequence″: “1”,
}

Function addOffice

An Office cannot exist without organization.

1. URL

a. https://api.mscc.solutions

b. /v1/organizations/offices

2. HTTP METHOD:
a. POST

3. Add a new office.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccOffice | | plain | object: MsccOffice | The office. |
| | mscc_org | plain | xsd: String | Identity for organization. |
| | mscc_offid | plain | | Identity for office |
| | mscc_addr1 | plain | | Office address |
| | mscc_addr2 | plain | | Office address. |
| | mscc_city | | | |
| | mscc_juridiction | | | |
| | mscc_main_tele | | | |
| | mscc_office_desc | | | |
| | mscc_postal | | | |
| | mscc_website | | | |
| | mscc_offid_created_ts | | | |
| | mscc_offid_deactivated_ts | | | |
| msccOrganization | | plain | object: MsccObject | The organization. |
| | mscc_org | plain | xsd: String | Company code. |
| | mscc_org_country | | | |
| | mscc_org_gov_level | | | |
| | mscc_org_name | | | |
| | mscc_org_type | | | |
| | mscc_org_created_ts | | | |
| | mscc_org_deactivated_ts | | | |

| | | | |
|---|---|---|---|
| msccIdentityUser | plain | object: MsccIdentity | The operator. |

mscc_org_owner
mscc_org_offid
mscc_org_user

{
″″: “”,
}

7. Response Parameter:

| Parameter | Style | Type | Description |
|---|---|---|---|
| MSCC_OFFID_CREATED_TS | plain | xsd: datetime | Timestamp. |

{
″ MSCC_OFFID_CREATED_TS ″: “20161010101010”,
}

Function addOrganization

An Organization is an identity namespace.

1. URL
a. https://api.mscc.solutions
b. /v1/organizations/

2. HTTP METHOD:
a. POST

3. Add a new organization.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415)

6. Request Parameter:

| Parameter | Style | Type | Description |
|---|---|---|---|
| msccOrganization | plain | object: MsccOrganization | The organization. |

mscc_org
mscc_org_country
mscc_org_gov_level
mscc_org_name
mscc_org_type
mscc_org_created_ts
mscc_org_deactivated_ts

| | | | |
|---|---|---|---|
| msccIdentityUser | plain | object: MsccIdentity | The operator. |

mscc_org_owner
mscc_org_offid
mscc_org_user

{
″″: “”,
}

7. Response Parameter:

| Parameter | Style | Type | Description |
|---|---|---|---|
| MSCC_ORG_CREATED_TS | plain | xsd: Datetime | Timestamp. |

{
″ MSCC_ORG_CREATED_TS ″: “20161010101010”,
}

Function addPermissions

A permission is a set of accessibility to be granted to an object level in the repository of MSCC domain. The permission of a folder is also identified by the object it associated. By the security model definition of MSCC, objects stored at any identity level, no further qualified by both same level or lower level identity(ices)-are available to any user. Creator and owner are the peers from an access standpoint. Organization is the root identity, manages authentication and authorization for any identity(ices) belong to it. MSCC does not restrict object storage or usage of the object. MSCC is not responsible for any invalid or illegal access right grant and revocation.

1. URL
a. https://api.mscc.solutions
b. /v1/collections/objects/permissions

2. HTTP Method
a. POST

3. Add permissions to an object.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415)

6. Request Parameter:

| Parameter | | Style | Type | Description |
|---|---|---|---|---|
| msccCollection | | plain | object: MsccCollection | If 2^{nd} parameter is null, |
| | | | | then will add requested |
| | | | | permission to all the |
| | | | | objects it is containing. |
| | mscc_org_owner | plain | xsd: String | Identity for organization. |
| | mscc_org_offid | plain | xsd: String | Identity for office |
| | mscc_org_user | plain | xsd: String | Identity for user |
| | mscc_ref_nbr | plain | xsd: String | Reference tag. |
| | mscc_account_owner | | | |
| | mscc_sub_account_owner | | | |
| | mscc_dialog_share | | | |
| | mscc_dialog_type | | | |
| msccObject | | plain | object: MsccObject | If it is not null, then will |
| | | | | only add requested |
| | | | | permission to this |
| | mscc_org_owner | plain | | object, no matter the 1^{st} |

parameter is null or not.

mscc_org_offid
mscc_org_user
mscc_ref_nbr
mscc_object_sequence
mscc_object_handle
mscc_acq_user_service
mscc_time_created
mscc_creation_method
mscc_time_ingested
mscc_md5_value
mscc_ingest_method
mscc_object_type
mscc_instructions

| | | | |
|---|---|---|---|
| msccIdentityGrantee | plain | object: MsccIdentity | The grantee. |

mscc_org_owner
mscc_org_offid
mscc_org_user

| | | | |
|---|---|---|---|
| msccIdentityGrantor | plain | object: MsccIdentity | The grantor. |

mscc_org_owner
mscc_org_offid
mscc_org_user

{
″″: “”,
}

7. Response Parameter:

| Parameter | Style | Type | Description |
|---|---|---|---|
| MSCC_TIME_SENT_TS | plain | xsd: | Timestamp when |
| | | Datetime | permission is created. |

{
″MSCC_TIME_SENT_TS″: “201601021010111”,
}

Function addUser

A user is an identity exists in organization namespace.

1. URL
a. https://api.mscc.solutions
b. /v 1/organizations/users

2. HTTP METHOD:
a. POST

3. Add a new user.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccOrganization | | plain | object: MsccOrganization | The organization. |
| | mscc_org | plain | xsd: String | Identity for |

organization.

mscc_org_country
mscc_org_gov_level
mscc_org_name
mscc_org_type
mscc_org_created_ts
mscc_org_deactivated_ts

| | | | |
|---|---|---|---|
| msccUser | plain | Object: MsccUser | The user. |

| | |
|---|---|
| mscc_org | plain |
| mscc_user | plain |
| mscc_user_name | plain |
| mscc_personal_title | plain |
| mscc_tele_daytime | plain |
| mscc_tele_offhours | plain |
| mscc_timezone | plain |
| mscc_title | plain |
| mscc_user_credential | plain |
| mscc_user_email | plain |
| mscc_user_created_ts | plain |
| mscc_user_deactivated_ts | plain |

| | | | |
|---|---|---|---|
| msccIdentityUser | Plain | object: MsccIdentity | The operator. |

mscc_org_owner
mscc_org_offid
mscc_org_user

{
″″: “”,
}

7. Response Parameter:

| Parameter | Style | Type | Description |
|---|---|---|---|
| MSCC_USER_CREATED_TS | plain | xsd: | Timestamp when |
| | | Datetime | user is created. |

{
″MSCC_USER_CREATED_TS″: “201601021010111”,
}

Function deleteFolder

Although folder is deleted, the content is still available.

1. URL
a. https://api.mscc.solutions
b. /v1/folders/

2. HTTP METHOD:
a. DELETE

3. Delete a current folder.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccFolder | | plain | object: | The folder. |
| | | | MsccFolder | |
| | mscc_org_folder | plain | xsd: String | |
| | mscc_offid_folder | plain | | |
| | mscc_user_folder | plain | | |
| | mscc_folder | plain | | |
| | mscc_org_collection | | | |
| | mscc_offid_collection | | | |
| | mscc_user_collection | | | |
| | mccc_ref_nbr_collection | | | |
| msccIdentityUser | | Plain | object: | The operator. |
| | mscc_org_owner | | MsccIdentity | |
| | mscc_org_offid | | | |
| | mscc_org_user | | | |

{
″″: “”,
}

7. Response Parameter:

| Parameter | Style | Type | Description |
|---|---|---|---|
| MSCC_OBSOLETION_TS | plain | xsd: Datetime | Timestamp when |
| | | | folder is deleted. |

{
″ MSCC_OBSOLETION_TS ″: “201601021010111”,
}

Function emailObjects

One of object delivery method.

1. URL
a. https://api.mscc.solutions
b. /v1/collections/objects/emails

2. HTTP METHOD:
a. GET

3. Email an object.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccObject | | plain | List: MsccObject | The object. |
| | mscc_org_owner | plain | xsd: String | |
| | mscc_org_offid | plain | | |
| | mscc_org_user | plain | | |
| | | plain | | |
| | mscc_ref_nbr | | | |
| | mscc_object_sequence | | | |
| | mscc_object_handle | | | |
| | mscc_acq_user_service | | | |
| | mscc_time_created | | | |
| | mscc_creation_method | | | |
| | mscc_time_ingested | | | |
| | mscc_md5_value | | | |
| | mscc_ingest_method | | | |
| | mscc_object_type | | | |
| | mscc_instructions | | | |
| msccEmailFact | | Plain | Object: MsccEmailFact | The email fact. |
| | emailTo | Plain | object: MsccIdentity | The receiver. |
| | emailSubject | Plain | | |
| | emailMessge | Plain | | |
| | emailCc | Plain | | |

| | | | |
|---|---|---|---|
| msccEmailTemplate | plain | Xsd: String | The email |
| | | | sending |
| | | | template. |
| | | | The default |
| | | | template is |
| | | | being used if |
| | | | it's null. |
| msccIdentitySender | Plain | object: MsccIdentity | The sender. |

mscc_org_owner
mscc_org_offid
mscc_org_user

{
″″: “”,
}

7. Response Parameter:

| Parameter | Style | Type | Description |
|---|---|---|---|
| MSCC_LOG_TS | plain | xsd: Datetime | Timestamp when |
| | | | email is sent. |

{
″ MSCC_LOG_TS ″: “201601021010111”,
}

Function getCollectionsInFolder

Retrieve the collections contained in the folder.

1. URL
a. https://api.mscc.solutions
b. /v1/folders/collections

2. HTTP METHOD:
a. GET

3. Retrieve collections.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccFolder | plain | object: MsccFolder | The folder. |
| mscc_org_folder | plain | xsd: String | |
| mscc_offid_folder | plain | | |
| | plain | | |
| mscc_user_folder | plain | | |
| mscc_folder | | | |
| mscc_org_collection | | | |
| mscc_offid_collection | | | |
| mscc_user_collection | | | |
| mccc_ref_nbr_collection | | | |
| msccQueryCriteria | Query | Object: MsccQueryCriteria | Query builder. |
| fuzzyQuery | Plain | Xsd: Boolean | |
| startSequence | Plain | | |
| pageSize | Plain | | |
| pageNumber | Plain | | |
| maxCount | Plain | | |
| accessIdentity | Plain | object: MsccIdentity | |
| groupBy | Plain | List: MsccMetadata | |
| OrderBy | Plain | List: MsccMetadata | |
| msccIdentityUser | Plain | object: MsccIdentity | The sender. |
| mscc_org_owner | | | |
| mscc_org_offid | | | |
| mscc_org_user | | | |

{
″″: “”,
}

7. Response Parameter:

| Parameter | Style | Type | Description |
|---|---|---|---|
| COLLECTIONS | plain | List: MsccCollection | List of collections. |

{
“ COLLECTIONS ”: { },
}

Function getObjectsByCollection

Retrieve the objects contained in the collection.

1. URL
a. https://api.mscc.solutions
b. /v1/collections/objects

2. HTTP METHOD:
a. GET

3. Retrieve objects.

4. Normal response codes:

a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccCollection | plain | object: MsccCollection | The collection. |
| mscc_org_owner | plain | xsd: String | |
| mscc_org_offid | plain | | |
| mscc_org_user | plain | | |
| mscc_ref_nbr | plain | | |
| mscc_account_owner | | | |
| mscc_sub_account_owner | | | |
| mscc_dialog_share | | | |
| mscc_dialog_type | | | |
| msccQueryCriteria | Query | Object: MsccQueryCriteria | Query builder. |
| fuzzyQuery | Plain | Xsd: Boolean | |
| startSequence | Plain | | |
| pageSize | Plain | | |
| pageNumber | Plain | | |
| maxCount | Plain | | |
| accessIdentity | Plain | object: MsccIdentity | |
| groupBy | | | |
| OrderBy | | | |
| msccIdentityUser | Plain | object: MsccIdentity | The user |
| mscc_org_owner | | | |
| mscc_org_offid | | | |
| mscc_org_user | | | |

{
″″: “”,
}

7. Response Parameter:

| Parameter | Style | Type | Description |
|---|---|---|---|
| OBJECTS | plain | List: MsccObject | List of objects. |

{
“ OBJECTS ”: { },
}

Function getObjectsByKey

Retrieve the objects by list of identity.

1. URL
a. https://api.mscc.solutions
b. /v1/collections/objects/keys

2. HTTP METHOD:
a. GET

3. Retrieve objects.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccIdentityKey | plain | List: MsccIdentity | The list of identity. |
| msccc_org_owner | plain | xsd: String | |
| mscc_offid_owner | plain | | |
| mscc_user_owner | plain | | |
| mscc_ref_nbr | plain | | |
| mscc_object_sequence | | | |
| mscc_object_handle | | | |
| mscc_acq_user_service | | | |
| mscc_time_created | | | |
| mscc_creation_method | | | |
| mscc_time_ingested | | | |
| mscc_md5_value | | | |
| mscc_ingest_method | | | |
| mscc_object_type | | | |
| mscc_instructions | | | |
| msccQueryCriteria | Query | Object: MsccQueryCriteria | Query builder. |
| fuzzyQuery | Plain | Xsd: Boolean | |
| startSequence | Plain | | |
| pageSize | Plain | | |
| pageNumber | Plain | | |
| maxCount | Plain | | |
| accessIdentity | Plain | object: MsccIdentity | |
| | Plain | | |
| groupBy | Plain | | |
| OrderBy | | | |
| msccIdentityUser | Plain | object: MsccIdentity | The user |
| mscc_org_owner | | | |
| mscc_org_offid | | | |
| mscc_org_user | | | |

**If only one key was passed in, no need to define query criteria.

{
″″: “”,
}

7. Response Parameter:

| Parameter | Style | Type | Description |
|---|---|---|---|
| OBJECTS | plain | List: MsccObject | List of objects. |

{
“ OBJECTS ”: { },
}

Function getObjectsByReference

Retrieve the objects by reference of contained collections.

1. URL
a. https://api.mscc.solutions
b. /v1/collections/objects/references

2. HTTP METHOD:
a. GET

3. Retrieve objects.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccIdentityReference | plain | List: MsccIdentity | The list of identity. |
| mscc_org_owner | plain | xsd: String | |
| mscc_offid_owner | plain | | |
| mscc_user_owner | plain | | |
| mscc_ref_nbr | plain | | |
| mscc_account_owner | | | |
| mscc_sub_account_owner | | | |
| mscc_dialog_share | | | |
| mscc_dialog_type | | | |
| msccQueryCriteria | Query | Object: MsccQueryCriteria | Query builder. |
| fuzzyQuery | Plain | Xsd: Boolean | |
| startQuence | Plain | | |
| pageSize | Plain | | |
| pageNumber | Plain | | |
| maxCount | Plain | | |
| accessIdentity | Plain | object: MsccIdentity | |
| groupBy | Plain | | |
| OrderBy | Plain | | |
| msccIdentityUser | Plain | object: MsccIdentity | The user |
| mscc_org_owner | | | |
| mscc_org_offid | | | |
| mscc_org_user | | | |

{
″″: “”,
}

7. Response Parameter:

| Parameter | Style | Type | Description |
|---|---|---|---|
| OBJECTS | plain | List: MsccObject | List of objects. |

{
“ OBJECTS ”: { },
}

Function mailObjects

Request format

Response format

Function makeNewCollection

A collection contains zero or more objects. It is horizontal descriptor of contained objects. Each collection is owned by exactly one identity in the repository of MSCC at its life-cycle, such as organization, office, user. It is able to be authorized to another identity no matter both identities exist in the same identity namespace or not. A folder is a collection but it can only one and only one object to represent its physical path or link. It is enabled at this moment if mscc obsoletion is is null or mscc obsoletion is is future date time.

1. URL
a. https://api.mscc.solutions
b. /v1/collections

2. HTTP Method
a. POST

3. Add a new collection

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccCollectionCreate | plain | object: MsccCollection | The information for |
| | | | a collection. |
| mscc_ref_nbr | plain | xsd: String | |
| | | | reference |
| mscc_dialog_type | plain | object: DialogType | |
| | | | App-defined |
| mscc_dialog_share | plain | object: DialogShare | |
| | | | Accessibility |
| mscc_account_owner | | | |
| mscc_sub_account_owner | | | |
| mscc_dialog_share | | | |
| mscc_dialog_type | | | |
| msccIdentityOwner | plain | object: MsccIdentity | The Identification of |
| | | | owner. |
| mscc_org_owner | | | |
| mscc_offid_owner | | | |
| mscc_user_owner | | | |
| msccFolder | plain | object: MsccFolder | The metadata for a |
| | | | folder resource. |
| mscc_org_folder | | | |
| mscc_offid_folder | | | |
| mscc_user_folder | | | |
| mscc_folder | | | |
| mscc_org_collection | | | |
| mscc_offid_collection | | | |
| mscc_user_collection | | | |
| mccc_ref_nbr_collection | | | |
| msccIdentityCreator | plain | object: MsccIdentity | The proxy of an |
| | | | owner. |
| mscc_org_owner | | | |
| mscc_offid_owner | | | |
| mscc_user _owner | | | |
| msccCollectionResponse | plain | object: MsccCollection | The content for a |
| | | | responded |
| mscc_org_owner | | | collection. |
| mscc_offid_owner | | | |
| mscc_user_owner | | | |
| mscc_ref_nbr | | | |
| mscc_account_owner | | | |
| mscc_sub_account_owner | | | |
| mscc_dialog_share | | | |
| mscc_dialog_type | | | |

{
″″: “”,
}

7. Response Parameter:

| Parameter | Style | Type | Description |
|---|---|---|---|
| MSCC_HALFALOGUE_START_TS | plain | xsd: | The time- |
| | | Datetime | stamp when |
| | | | collection |
| | | | is created. |

{
″halfalogue″: “20160101010101111”,
}

8. If office, user, folder doesn't exist then create them at this moment

Function printObjects

Print objects.

1. URL
a. https://api.mscc.solutions
b. /v1/collections/objects/print

2. HTTP METHOD:
a. GET

3. Print an object.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccObject | plain | object: MsccObject | The object. |
| mscc_org_owner | plain | xsd: String | |
| mscc_offid_owner | plain | | |
| mscc_user_owner | plain | | |
| mscc_ref_nbr | plain | | |
| mscc_object_sequence | | | |
| mscc_object_handle | | | |
| mscc_acq_user_service | | | |
| mscc_time_created | | | |
| mscc_creation_method | | | |
| mscc_time_ingested | | | |
| mscc_md5_value | | | |
| mscc_ingest_method | | | |
| mscc_object_type | | | |
| mscc_instructions | | | |
| msccPrintFact | Plain | Object: MsccPrintFact | The printer fact. |
| printerTo | Plain | List: MsccPrinter | The printer. |
| msccPrintTemplate | plain | Xsd: String | The object print |
| | | | template. |
| | | | The default |
| | | | template is |
| | | | being used if it's |
| | | | null. |
| msccIdentityPrinter | Plain | object: MsccIdentity | The sender. |
| mscc_org_owner | | | |
| mscc_offid_owner | | | |
| mscc_user_owner | | | |

{
″″: “”,
}

7. Response Parameter:

| Parameter | Style | Type | Description |
|---|---|---|---|
| MSCC_LOG_TS | plain | xsd: Datetime | Timestamp when |
| | | | email is sent. |

{
″ MSCC_LOG_TS ″: “201601021010111”,
}

[symbol] “SUCCESS”

Function recordAction

The user response to a request action.

1. URL
a. https://api.mscc.solutions
b. /v1/collections/objects/actions/taken

2. HTTP Method
a. POST

3. Response a request.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccActionTaken | plain | object: | The request. |
| | | MsccActionTaken | |
| mscc_org_owner_sent | | | Identity for |
| | | | organization |
| mscc_offid_owner_sent | plain | | |
| | | xsd: String | Identity for office |
| mscc_user_owner_sent | plain | | |
| | | xsd: String | Identity for user |
| mscc_ref_nbr_sent | plain | | |
| | | xsd: String | Reference tag. |
| mscc_object_sequence_sent | plain | | |
| | | xsd: String | |
| mscc_org_sent | | | |
| mscc_offid_sent | | | |
| mscc_user_sent | | | |
| mscc_access_rights_sent_to | | | |
| mscc_time_sent_ts | | | |
| mssc_time_action_ts | | | |
| msccObjectResponse | plain | object: MsccObject | The response |
| | | | object, can be |
| mscc_org_owner_action | plain | | null. |
| mscc_org_offid_action | | | |
| mscc_org_user_action | | | |
| MSCC_REF_nbr_action | | | |
| mscc_object_sequence_action | | | |
| mscc_user_took_action_name | plain | Xsd: String | The grantee. |
| mscc_user_took_action_email | | | |
| mscc_user_took_action_tele | | | |

{
″″: “”,
}

7. Response Parameter:

| Parameter | Style | Type | Description |
|---|---|---|---|
| MSCC_TIME_SENT_TS | plain | xsd: | Timestamp when |
| | | Datetime | permission is created. |

{
″MSCC_TIME_ACTION_TS″: “201601021010111”,
}

Function removeCollectionFromFolder

A Folder is another type of collection. The function provides a tool for user to manage the collections. It can be associated with physical file path or not. A folder can only contain collections, including other folders. Any object except representation of itself, is prohibited to be associated.

1. URL
a. https://api.mscc.solutions
b. /v1/folders/collections

2. HTTP Method
a. DELETE

3. Remove collections from a folder.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415)/

6. Request Parameter:

| Parameter | Style | Type | Description |
|---|---|---|---|
| msccCollection | plain | object: MsccCollection | The contained |
| | | | collection. |
| mscc_org_owner | | | |
| mscc_offid_owner | | | |
| mscc_user_owner | | | |
| mscc_ref_nbr | | | |
| mscc_account_owner | | | |
| mscc_sub_account_owner | | | |
| mscp_dialog_share | | | |
| mscc_dialog_type | | | |
| msccFolder | plain | object: MsccFolder | The target folder. |
| mscc_org_folder | | | |
| mscc_offid_folder | | | |
| mscc_user_folder | | | |
| mscc_folder | | | |
| mscc_org_collection | | | |
| mscc_offid_collection | | | |
| mscc_user_collection | | | |
| mscc_ref_nbr_collection | | | |
| msccIdentityUser | plain | object: MsccIdentity | The user(operator) |
| mscc_org_owner | | | |
| mscc_offid_owner | | | |
| mscc_user_owner | | | |

{
″″: “”,
}

7. Response Parameter:

| | | | |
|---|---|---|---|
| MSCC_HALFALOGUE_START_TS | plain | xsd: | The timestamp |
| | | String | of folder. |

{
″ MSCC_HALFALOGUE_START_TS ″: “201601010101010000”,
}

Function removeOffice

Remove an office from an organization namespace.

1. URL
a. https://api.mscc.solutions
b. /v1/organizations/offices

2. HTTP METHOD:
a. DELETE

3. Remove a new office.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccOffice | plain | object: MsccOffice | The office. |
| mscc_org | plain | xsd: String | Identity for |
| | | | organization. |
| mscc_offid | plain | xsd: String | |
| | | | Identity for office |
| mscc_addr1 | plain | xsd: String | |
| | | | Office address1 |
| mscc_addr2 | plain | xsd: String | |
| | | | Office address2. |
| mscc_city | | | |
| mscc_juridiction | | | |
| mscc_main_tele | | | |
| mscc_office_desc | | | |
| mscc_postal | | | |
| mscc_website | | | |
| mscc_office_created_ts | | | |
| mscc_office_deactivated_ts | | | |
| msccIdentityUser | plain | object: MsccIdentity | The operator. |
| mscc_org_owner | | | |
| mscc_offid_owner | | | |
| mscc_user_owner | | | |

{
″″: “”,
}

7. Response Parameter:

| Parameter | Style | Type | Description |
|---|---|---|---|
| MSCC_OFFID_DEACTIVATED_TS | plain | xsd: | Timestamp. |
| | | Datetime | |

{
″ MSCC_OFFID_DEACTIVATED_TS″: “20161010101010”,
}

Function removeOrganization

An Organization is an identity namespace.

1. URL
a. https://api.mscc.solutions
b. /v1/organizations

2. HTTP METHOD:
a. DELETE

3. Add a new organization.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccOrganization | plain | object: MsccOrganization | The organization |
| mscc_org | plain | xsd: String | Identity for |
| | | | organization. |
| mscc_org_country | plain | xsd: String | |
| mscc_org_gov_level | plain | xsd: String | |
| mscc_org_name | plain | xsd: String | |
| mscc_org_type | | | |
| mscc_org_created_ts | | | |
| mscc_org_deactivated_ts | | | |
| msccIdentityUser | plain | object: MsccIdentity | The operator. |
| mscc_org_owner | | | |
| mscc_offid_owner | | | |
| mscc_user_owner | | | |

{
″″: “”,
}

7. Response Parameter:

| Parameter | Style | Type | Description |
|---|---|---|---|
| MSCC_ORG_DEACTIVATED_TS | plain | xsd: | Timestamp. |
| | | Datetime | |

{
″ MSCC_ORG_DEACTIVATED_TS ″: “20161010101010”,
}

Function removePermissions

Remove granted permissions.

1. URL
a. https://api.mscc.solutions
b. /v1/collections/objects/permissions

2. HTTP Method
a. DELETE

3. Add permissions to an object.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccCollection | plain | object: | If 2^{nd} parameter is null, |
| | | MsccCollection | then will add requested |
| | | | permission to all the |
| | | | objects it is containing. |
| mscc_org_owner | plain | | |
| | | xsd: String | Identity for organization. |
| mscc_offid_owner | plain | | |
| | | xsd: String | Identity for office |
| mscc_user_owner | plain | | |
| | | xsd: String | Identity for user |
| mscc_ref_nbr | plain | | |
| | | xsd: String | Reference tag. |
| mscc_account_owner | | | |
| mscc_sub_account_owner | | | |
| mscc_dialog_share | | | |
| mscc_dialog_type | | | |
| msccObject | plain | object: MsccObject | If it is not null, then will |
| | | | only add requested |
| mscc_org_owner | plain | | permission to this object, |
| | | | no matter the 1^{st} |
| mscc_org_offid | | | parameter is null or not. |
| mscc_org_user | | | |
| MSCC_REF_nbr | | | |
| mscc_object_sequence | | | |
| mscc_object_handle | | | |
| mscc_acq_user_service | | | |
| mscc_time_created | | | |
| mscc_creation_method | | | |
| mscc_time_ingested | | | |
| mscc_md5_value | | | |
| mscc_ingest_method | | | |
| mscc_object_type | | | |
| mscc_instructions | | | |
| msccIdentityGrantee | plain | object MsccIdentity | The grantee. |
| mscc_org_owner | | | |
| mscc_offid_owner | | | |
| mscc_user_owner | | | |
| msccIdentityGrantor | plain | object: MsccIdentity | The grantor. |
| mscc_org_owner | | | |
| mscc_offid_owner | | | |
| mscc_user_owner | | | |

{
″″: “”,
}

7. Response Parameter:

| Parameter | Style | Type | Description |
|---|---|---|---|
| MSCC_TIME_ACTION_REQUIRED | plain | xsd: | Timestamp |
| | | Datetime | when |
| | | | permissio |
| | | | is created. |

{
″ MSCC_TIME_ACTION_REQUIRED″: “201601021010111”,
}

Function removeUser

A user is an identity exists in organization namespace.

1. URL
a. https://api.mscc.solutions
b. /v1/organizations/users

2. HTTP METHOD:
a. DELETE

3. Add a new user.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccUser | | plain | Object: | The user. |
| | mscc_org | plain | MsccUser | |
| | mscc_user | plain | | |
| | mscc_user_name | plain | | |
| | mscc_personal_title | plain | | |
| | mscc_tele_daytime | plain | | |
| | mscc_tele_offhours | plain | | |
| | mscc_timezone | plain | | |
| | mscc_title | plain | | |
| | mscc_user_credential | plain | | |
| | mscc_user_email | plain | | |
| | mscc_user_created_ts | plain | | |
| mscc_user_deactivated_ts | | plain | | |
| msccIdentityUser | | Plain | object: | The operator. |
| | mscc_org_owner | | MsccIdentity | |
| | mscc_offid_owner | | | |
| | mscc_user_owner | | | |

{
″″: “”,
}

7. Response Parameter:

| Parameter | Style | Type | Description |
|---|---|---|---|
| MSCC_USER_DEACTIVATED_TS | plain | xsd: | Timestamp |
| | | Datetime | when |
| | | | user is |
| | | | created. |

{
″MSCC_USER_DEACTIVATED_TS″: “201601021010111”,
}

Function searchObjectsByMetadata

Retrieve the objects by metadata.

1. URL
a. https://api.mscc.solutions
b. /v1/collections/objects/metadata

2. HTTP METHOD:
a. GET

3. Retrieve objects.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccMetadata | | plain | List: MsccMetadata | The list of metadata. |
| | mscc_org_owner | | | |
| | mscc_org_offid | plain | xsd: String | |
| | mscc_org_user | plain | | |
| | MSCC_REF_nbr | | | |
| | mscc_object_sequence | | | |
| | mscc_meta_type | | | |
| | mscc_meta_value | | | |
| msccQueryCriteria | | Query | Object: MsccQueryCriteria | Query builder. |
| | fuzzyQuery | Plain | Xsd: Boolean | |
| | startQuence | Plain | | |
| | pageSize | Plain | | |
| | pageNumber | Plain | | |
| | maxCount | Plain | | |
| | accessIdentity | Plain | Object: MsccIdentity | |
| | groupBy | Plain | | |
| | OrderBy | Plain | | |

| | | | |
|---|---|---|---|
| msccIdentityUser | Plain | object: MsccIdentity | The user |

{
“”: “”,
}

7. Response Parameter:

| Parameter | Style | Type | Description |
|---|---|---|---|
| OBJECTS | plain | List: MsccObject | List of objects. |

{
“ OBJECTS ”: { },
}

Function sendAction

An action is a set of combination of authorization and action to a specific “send-to” object. A user may take certain action to respond this “sent-to” action within certain amount time.

| | Read | | | | | |
|---|---|---|---|---|---|---|
| | Only | Request | Approval | Rejection | Update | Delete |
| REVIEW | | | | | | |
| AND | | | | | | |
| APPROVE | | | | | | |
| INFOR- | | | | | | |
| MATION | | | | | | |
| TAKE | | | | | | |
| OVER | | | | | | |
| OWNERS | | | | | | |
| HIP | | | | | | |
| RESUBMIT | | | | | | |
| SUBMIT | | | | | | |
| REVIEW | | | | | | |
| AND | | | | | | |
| COMMENT | | | | | | |
| PROCESS | | | | | | |

1. URL
a. https://api.mscc.solutions
b. /v1/collections/objects/actions

2.HTTP method
a. POST
3. Normal response codes:
a. 200 (Success)
4. Error response codes:
b. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccObjectCollection | | plain | object: MsccCollection | If 2^{nd} parameter is null, |
| | | plain | | then will add |
| | | | | requested permission |
| | | | | to all the objects it |
| | | | | contains. |
| | mscc_org_owner | plain | xsd: String | Identity for organization. |
| | mscc_org_offid | plain | xsd: String | Identity for office |
| | mscc_org_user | plain | xsd: String | Identity for user |
| | mscc_ref_nbr | | xsd: String | Reference tag. |
| | mscc_account_owner | | | |
| | mscc_sub_account_owner | | | |
| | mscc_dialog_share | | | |
| | mscc_dialog_type | | | |
| msccObject | | plain | object: MsccObject | If it is not null, then will |
| | mscc_org_owner | plain | | only add requested |
| | mscc_org_offid | | | permission to this |
| | mscc_org_user | | | object, no matter the |
| | mscc_ref_nbr | | | 1^{st} parameter is null or |
| | mscc_object_sequence | | | not. |
| | mscc_object_handle | | | |
| | mscc_acq_user_service | | | |
| | mscc_time_created | | | |
| | mscc_creation_method | | | |
| | mscc_time_ingested | | | |
| | mscc_md5_value | | | |
| | mscc_ingest_method | | | |
| | mscc_object_type | | | |
| | mscc_instructions | | | |
| msccIdentityGrantee | | plain | object: MsccIdentity | The grantee who will |
| | mscc_org_owner | | | be granted requested |
| | mscc_org_offid | | | permissions or |
| | mscc_org_user | | | authorizations |

| | | | |
|---|---|---|---|
| msccSentTo | Plain | List: MsccSentTo | The granted actions. |
| mscc_access_rights_sent_to | Plain | enum: MsccActionRight | Definition of rights |
| mscc_time_action_required | Plain | Xsd: datetime | Expiration |
| mscc_action_desc_sent_to | Plain | Xsd: String | Description for action |
| mscc_action_requested_sent_to | Plain | Enum: msccActionRequest | Definition of request |
| mscc_action_sender_priorty | Plain | Enum: msccActionPriorty | Definition of priority |
| mscc_action_action_status | Plain | Xsd: String | Action status |
| msccIdentityGrantor | plain | object: MsccIdentity | The grantor. |

mscc_org_owner
mscc_org_offid
mscc_org_user

{
″″: “”,
}

7. Response Parameter:

| Parameter | Style | Type | Description |
|---|---|---|---|
| MSCC_TIME_SENT_TS | plain | xsd: Datetime | Timestamp when |
| | | | action is sent. |

{
″ MSCC_TIME_SENT_TS″: “201601021010111”,
}

Function transferCreator

Transfer creator of a collection.

1. URL
a. https://api.mscc.solutions
b. /v1/collections/creators

2. HTTP METHOD:
a. PUT

3. Update creator of a collection.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msecCollection | | plain | object: MsccCollection | The collection. |
| | mscc_org_owner | plain | xsd: String | |
| | mscc_offid_owner | plain | | |
| | mscc_user_owner | plain | | |
| | mscc_ref_nbr | plain | | |
| | mscc_account_owner | | | |
| | mscc_sub_account_owner | | | |
| | mscc_dialog_share | | | |
| | mscc_dialog_type | | | |

| | | | |
|---|---|---|---|
| msccIdentityCreator | Query | Object: MsccIdentity | New creator. |

| | |
|---|---|
| mscc_org_owner | Plain |
| mscc_offid_owner | Plain |
| mscc_user_owner | Plain |

| | | | |
|---|---|---|---|
| msccIdentityUser | Plain | object: MsccIdentity | The user |

mscc_org_owner
mscc_offid_owner
mscc_user_owner

{
″″: “”,
}

7. Response Parameter:

| Parameter | Style | Type | Description |
|---|---|---|---|
| MSCC_ORG_OWNER | plain | Xsd: String | Creator. |

{
“MSCC_ORG_OWNER ”: { },
}

Function transferOwner

Transfer creator of a collection.

1. URL
a. https://api.mscc.solutions
b. /v1/collections/owners

2. HTTP METHOD:
a. PUT

3. Update creator of a collection.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccCollection | | plain | object: MsccCollection | The collection. |
| | mscc_org_owner | plain | xsd: String | |
| | mscc_offid_owner | plain | | |
| | mscc_user_owner | plain | | |
| | mscc_ref_nbr | plain | | |
| | mscc_account_owner | | | |
| | mscc_sub_account_owner | | | |
| | mscc_dialog_share | | | |
| | mscc_dialog_type | | | |

| | | | |
|---|---|---|---|
| msccIdentityOwner | Query | Object: MsccIdentity | New creator. |

| | |
|---|---|
| mscc_org_owner | Plain |
| mscc_offid_owner | Plain |
| mscc_user_owner | Plain |

| | | | |
|---|---|---|---|
| msccIdentityUser | Plain | object: MsccIdentity | The user |

mscc_org_owner
mscc_offid_owner
mscc_user_owner

{
″″: “”,
}

7. Response Parameter:

| Parameter | Style | Type | Description |
|---|---|---|---|
| MSCC_ORG_OWNER | plain | Xsd: String | Creator. |

{
“MSCC_ORG_OWNER ”: { },
}

Function unsendAction

An action is a set of combination of authorization and action to a specific “send-to” object. A user may take certain action to respond this “sent-to” action within certain amount time.

| | | | | | |
|---|---|---|---|---|---|
| Read | | Ap- | Rejec- | | |
| Only | Request | proval | tion | Update | Delete |

REVIEW AND
APPROVE
INFORMATION
TAKE OVER
OWNERSHIP
RESUBMIT
SUBMIT
REVIEW AND
COMMENT
PROCESS

1. URL
a. https://api.mscc.solutions
b. /v1/collections/objects/actions

2. HTTP method
a. DELETE

3. Normal response codes:
a. 200 (Success)

4. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccActionTaken | plain | object: | Action. |
| mscc_org_owner_sent | | MsccActionTaken | |
| mscc_offid_owner_sent | | | |
| mscc_user_owner_sent | | | |
| mscc_ref_nbr_sent | | | |
| mscc_object_sequence_sent | | | |
| mscc_org_sent | | | |
| mscc_offid_sent | | | |
| mscc_user_sent | | | |
| mscc_access_rights_sent_to | | | |
| mscc_time_sent_ts | | | |
| mscc_org_owner_action | | | |
| mscc_offid_owner_action | | | |
| mscc_user_owner_action | | | |
| mscc_ref_nbr_action | | | |
| mscc_object_sequence_action | | | |
| mscc_user_took_action_name | | | |
| mscc_usre_took_action_email | | | |
| mscc_user_took_action_tele | | | |
| msccIdentityUser | plain | object: | The user |
| | | MsccIdentity | |

{
″″: “”,
}

7. Response Parameter:

| Parameter | Style | Type | Description |
|---|---|---|---|
| MSCC_TIME_ACTION_TS | plain | xsd: | Timestamp when |
| | | Datetime | action is sent. |

{
″ MSCC_TIME_ACTION_TS″: “201601021010111”,
}

Function updateCollection

Update metadata of a collection.

1. URL
a. https://api.mscc.solutions
b. /v1/collections/metadatas

2. HTTP METHOD:
a. PUT

3. Update metadata of a collection.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccCollection | | plain | object: | The collection. |
| | mscc_org_owner | | MsccCollection | |
| | mscc_offid_owner | | | |
| | mscc_user_owner | | | |
| | mscc_ref_nbr | | | |
| | mscc_account_owner | | | |
| | mscc_sub_account_owner | | | |
| | mscc_dialog_share | | | |
| | mscc_dialog_type | | | |
| msccMetadataUpdate | | plain | List: | Metadata list. |
| | mscc_org_owner | | MsccMetadata | |
| | mscc_offid_owner | | | |
| | mscc_user_owner | | | |
| | mscc_ref_nbr | | | |
| | mscc_object_sequence | | | |
| | mscc_meta_type | | | |
| | mscc_meta_value | | | |
| msccIdentityUser | | Plain | object: | The user |
| | mscc_org_owner | | MsccIdentity | |
| | mscc_offid_owner | | | |
| | mscc_user_owner | | | |

{
″″: “”,
}

7. Response Parameter:

| Parameter | Style | Type | Description |
|---|---|---|---|
| MSCC_TS_META | plain | List: String | Last timestamp. |

{
″ MSCC_TS_META ″: {“201601010101100”}
}

Function updateObject

Update metadata of an object.

1. URL
a. https://api.mscc.solutions
b. /v1/collections/objects/metadatas

2. HTTP METHOD:
a. PUT

3. Update metadata of an object.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccObject | | plain | object: | The Object. |
| | mscc_org_owner | | MsccObject | |
| | mscc_offid_owner | | | |
| | mscc_user_owner | | | |
| | mscc_ref_nbr | | | |
| | mscc_object_sequence | | | |
| | mscc_object_handle | | | |
| | mscc_acq_user_service | | | |
| | mscc_time_created | | | |
| | mscc_creation_method | | | |
| | mscc_time_ingested | | | |
| | mscc_md5_value | | | |
| msccMetadataUpdate | | plain | List: | Metadata list. |
| | mscc_org_owner | | MsccMetadata | |
| | mscc_offid_owner | | | |
| | mscc_user_owner | | | |
| | mscc_ref_nbr | | | |
| | mscc_object_sequence | | | |
| | mscc_meta_type | | | |
| | mscc_meta_value | | | |
| msccIdentityUser | | Plain | object: | The user |
| | mscc_org_owner | | MsccIdentity | |
| | mscc_offid_owner | | | |
| | mscc_user_owner | | | |

{
″″: “”,
}

7. Response Parameter:

| Parameter | Style | Type | Description |
|---|---|---|---|
| MSCC_TS_META | plain | List:String | Last timestamp. |

{
″ MSCC_TS_META ″: { “201601010101100” }
}

Function updateOffice

An Office cannot exist without organization.

1. URL
a. https://api.mscc.solutions
b. /v1/organizations/offices

2. HTTP METHOD:
a. PUT

3. Add a new office.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccOffice | | plain | object: | Old office. |
| | mscc_org | | MsccOffice | |
| | mscc_offid | | | |
| | mscc_addr1 | | | |
| | mscc_addr2 | | | |
| | mscc_city | | | |
| | mscc_juridiction | | | |
| | mscc_main_tele | | | |
| | mscc_office_desc | | | |
| | mscc_postal | | | |
| | mscc_website | | | |
| | mscc_offid_created_ts | | | |
| | mscc_offid_deactivated_ts | | | |
| msccOfficeUpdate | | plain | object: | New office. |
| | mscc_org | | MsccOffice | |
| | mscc_offid | | | |
| | mscc_addr1 | | | |
| | mscc_addr2 | | | |
| | mscc_city | | | |
| | mscc_juridiction | | | |
| | mscc_main_tele | | | |
| | mscc_office_desc | | | |
| | mscc_postal | | | |
| | mscc_website | | | |
| | mscc_offid_created_ts | | | |
| | mscc_offid_deactivated_ts | | | |
| msccIdentityUser | | plain | object: | The operator. |
| | mscc_org_owner | | MsccIdentity | |
| | mscc_offid_owner | | | |
| | mscc_user_owner | | | |

{
″″: “”,
}

7. Response Parameter:

| Parameter | Style | Type | Description |
|---|---|---|---|
| MSCC_USER_OFFID_CREATED_TS | plain | List: | Last |
| | | String | timestamp. |

{
″ MSCC_USER_OFFID_CREATED_TS″: {“201601010101100”}
}

Function updateOrganization

An Organization is an identity namespace.

1. URL
a. https://api.mscc.solutions
b. /v1/organizations/

2. HTTP METHOD:
a. PUT

3. Add a new organization.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | Style | Type | Description |
|---|---|---|---|
| msccOrganization | plain | object: MsccOrganization | Old organization. |

mscc_org
mscc_org_country
mscc_org_gov_level
mscc_org_name
mscc_org_type
mscc_org_created_ts
mscc_org_deactivated_ts

| | | | |
|---|---|---|---|
| msccOrganizationUpdate | plain | Object: MsccOrganization | New Organization |

mscc_org
mscc_org_country
mscc_org_gov_level
mscc_org_name
mscc_org_type
mscc_org_created_ts
mscc_org_deactivated_ts

| | | | |
|---|---|---|---|
| msccIdentityUser | plain | object: MsccIdentity | The operator. |

mscc_org_owner
mscc_offid_owner
mscc_user_owner

{
″″: “”,
}

7. Response Parameter:

| Parameter | Style | Type | Description |
|---|---|---|---|
| MSCC_ORG_CREATED_TS | plain | xsd: Datetime | Timestamp. |

{
″ MSCC_ORG_CREATED_TS ″: “20161010101010”,
}

Function updateUser

A user is an identity exists in organization namespace.

1. URL
a. https://api.mscc.solutions
b. /v1/organizations/users

2. HTTP METHOD:
a. PUT

3. Add a new user.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccUser | | plain | Object: | Old user. |
| | mscc_org | plain | MsccUser | |
| | mscc_user | plain | | |
| | mscc_user_name | plain | | |
| | mscc_personal_title | plain | | |
| | mscc_tele_daytime | plain | | |
| | mscc_tele_offhours | plain | | |
| | mscc_timezone | plain | | |
| | mscc_title | plain | | |
| | mscc_user_credential | plain | | |
| | mscc_user_email | plain | | |
| | mscc_user_created_ts | plain | | |
| mscc_user_deactivated_ts | | plain | | |
| msccUser | | | Object: | New user. |
| | mscc_org | | MsccUser | |
| | mscc_user | | | |
| | mscc_user_name | | | |
| | mscc_personal_title | | | |
| | mscc_tele_daytime | | | |
| | mscc_tele_offhours | | | |
| | mscc_timezone | | | |
| | mscc_title | | | |
| | mscc_user_credential | | | |
| | mscc_user_email | | | |
| | mscc_user_created_ts | | | |

| | | | |
|---|---|---|---|
| mscc_user_deactivated_ts | | | |
| msccIdentityUser | Plain | object: | The operator. |
| | | MsccIdentity | |

{
″″: “”,
}

7. Response Parameter:

| Parameter | Style | Type | Description |
|---|---|---|---|
| MSCC_USER_CREATED_TS | plain | xsd: | Timestamp when |
| | | Datetime | user is updated. |

{
″MSCC_USER_CREATED_TS″: “201601021010111”,
}

Function userToOffice

Add a user to an office.

1. URL
a. https://api.mscc.solutions
b. /v1/organizations/offices/users

2. HTTP METHOD:

a. POST

3. Add a new user.

4. Normal response codes:
a. 200 (Success)

5. Error response codes:
a. Bad Request (400), Unauthorized (40), Forbidden (403), Not Found (404), Method Not Allowed (405), Conflict (40), Service Unavailable (503), Unsupported Media Type (415).

6. Request Parameter:

| Parameter | | Style | Type | Description |
|---|---|---|---|---|
| msccOffice | | plain | Object: | Office |
| | mscc_org | | MsccOffice | |
| | mscc_offid | | | |
| | mscc_addr1 | | | |
| | mscc_addr2 | | | |
| | mscc_city | | | |
| | mscc_juridiction | | | |
| | mscc_main_tele | | | |
| | mscc_office_desc | | | |
| | mscc_postal | | | |
| | mscc_website | | | |
| msccUser | | | Object: | User. |
| | mscc_org | | MsccUser | |
| | mscc_user | | | |
| | mscc_user_name | | | |
| | mscc_personal_title | | | |
| | mscc_tele_daytime | | | |
| | mscc_tele_offhours | | | |
| | mscc_timezone | | | |
| | mscc_title | | | |
| | mscc_user_credential | | | |
| | mscc_user_email | | | |
| | mscc_user_created_ts | | | |
| mscc_user_deactivated_ts | | | | |
| msccIdentityUser | | Plain | object: | The operator. |
| | mscc_org_owner | | MsccIdentity | |
| | mscc_offid_owner | | | |
| | mscc_user_owner | | | |

{
″″: “”,
}

7. Response Parameter:

| Parameter | Style | Type | Description |
|---|---|---|---|
| MSCC_USER_OFFID_CREATED_TS | plain | xsd: | Timestamp |
| | | Date- | when |
| | | time | user is |
| | | | updated. |

{
″ MSCC_USER_OFFID_CREATED_TS″: “201601021010111”,
}

mServices Technology Framework

The following table is the technology development and operational framework.

| TECHNOLOGY ASPECT | MINIMUM REQUIREMENT |
|---|---|
| Language | Java (jdk 1.7) |
| Framework | Spring 4.x/Hibernate 4.x |
| Database | Oracle 12c |
| Operating System (Application, | Windows 2012R2 |
| Production) | |
| Build Tools | Maven |
| Repository | CVS |
| Runtime Environment | Websphere 8.5.5 (or greater) |
| Webservices | SOAP 1.2 JAX-WS |
| APIs | Dropbox, such as at |
| | https://www.dropbox.com/developers- |
| | v1/core/start/java |
| IDE | IntelliJ (latest version) or Eclipse (latest |
| | version) |

The communications center of the present invention may be implemented as follows. The communications center can be designed in a client-server architecture, in which the server side uses software written in java language operating in a virtual machine (MS-Windows®) on a Dell® PowerEdge server, for example. On the client side, software can be written in java language and included with a participating application on any operating system platform (real or virtual).

The server side employs a middleware layer, such as WebSphere® Application Server (WAS), java development kit (JDK) and java runtime environment (JRE). No middleware layer is required on the client side for the communications center of the present invention.

On the server side, the communications center of the present invention employs as a data layer, an Oracle® 12c database management system operating with Red Hat® Linux virtual machine or raw host on a Dell server with large-scale RAID10 array of self-encrypted storage. No data layer is required on the client side for the communications center of the present invention.

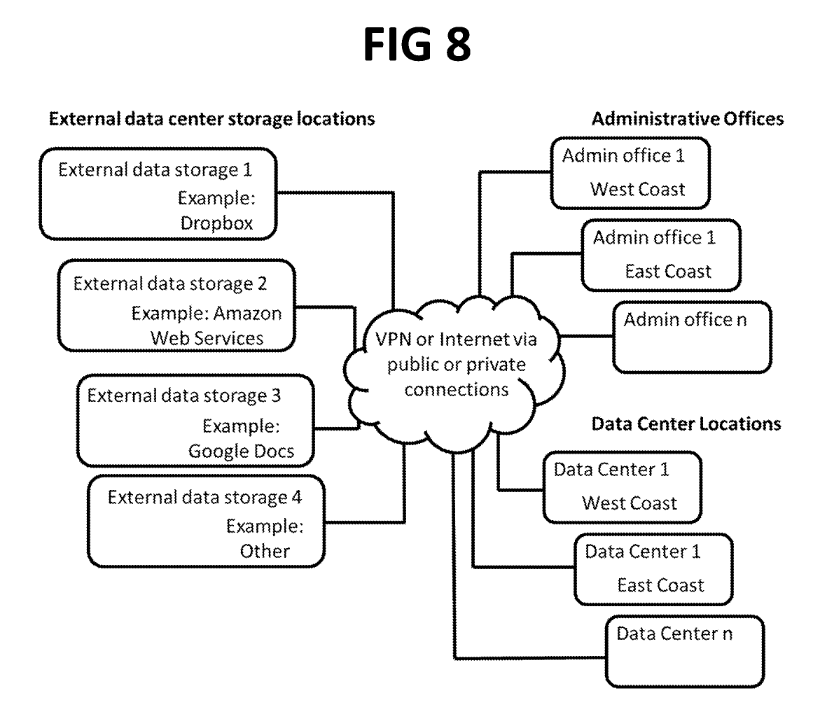

The communications center of the present invention may be implemented as a single server or multiple servers, an exemplary embodiment of which is shown in FIG. 8. In the case of multiple servers located in various geographically diverse locations, these servers could be connected via the Internet, a public network, a private network or VPN. The servers could be located in administrative offices with one or more data centers and one or more external data center storage locations, such as DropBox®, Amazon® Web Services, Google®docs, or some other proprietary service.

Example of Data Object

The following is an example of a data object from test system; it is a download of data from an IRP account. This data is used for an IRP audit. In the information below, the owner is “ADOT” which comes directly from the MSCC server database, indicating that a trusted organization (ADOT) created this record on behalf of itself.
From: LSC_dev@examplecompany [mailto:LSC_dev@examplecompany]
Sent: Monday, Dec. 12, 2016 8:56 PM
To: exampleperson <exampleperson@examplecompany>
Subject: IRP Audit Download—Please do not respond to this email
Do not reply to this email.
Sent by:
“State” Department of Transportation, Motor Vehicle Division
[cid:image001.png@01D26A4A.A816B3F0]
IRP processing by:
[cid:image002.png@01D26A4A.A816B3F0]

Information current as of Dec. 12, 2016 8:55:57 PM MST
The following information was forwarded by process: EMAIL Object 1: https://www.dropbox.com/s/5paofph8rid8ylq/IR000070495001201703161212203338119.txt
Sent By
Organization
ADOT
Office
1556
User
rylsc
Sent To
Organization
ADOT
Office
1556
User
rylsc
Data Object 1:
Date object posted
2016-12-13 03:54:16.049
Object Type
IRPAUDDL
Data Owner
Organization
ADOT
Office
1556
User
rylsc
Collection Ref
IR000070495001201703161212203338
Object Sequence
119
Action Request
INFORMATION

What is claimed is:

1. A method for providing electronic credentials to a licensee or registrant and a third party from an electronic data storage system comprising:
delivering by an issuer of an electronic credential a digital certificate representative of the electronic credential to a licensee's folder stored in the electronic data storage system;
enabling an authorized user of the licensee to share a link to a received digital certificate in the licensee's folder;
allowing the issuer to set or update an obsolescence characteristics of the digital certificate; and
sharing the link over a public network via a communications system to the third party.

2. The method according to claim 1, wherein the communications system comprises a file transport protocol system.

3. The method according to claim 1, wherein the data storage system stores data relevant to vehicle registrations.

4. The method according to claim 1, further comprising sharing by the owner or creator of data access to distance information and summaries.

5. The method according to claim 1, further comprising requesting actions by the owner or creator of data.

6. The method according to claim 1, further comprising tracking the accession of data objects.

7. The method according to claim 6, further comprising recording by a participant resulting data from the actions taken.

8. The method according to claim 1, wherein the data storage system stores data relevant to fuel tax reporting.

9. The method according to claim 1, further comprising sharing by an owner or creator of data access to distance information, fuel receipts and summaries.

10. The method according to claim 1, wherein the data storage system stores data relevant to motor carrier, registrant and shipper functions.

11. The method according to claim 6, further comprising recording by a participant resulting data from the actions taken, including recording the electronic (digital) credentials.

12. The method according to claim 1, further comprising enabling a participant to be authorized an ability to review, confer accession rights to others, and cause the data or a link to the data to be sent via one or more methods to participants and non-participants.

13. An apparatus for providing electronic credentials to a licensee and a third party comprising:
a data storage system to store one or more electronic credentials in one or more folders;
a communications system to deliver from an issuer of an electronic credential a digital certificate representative of the electronic credential to a licensee's folder stored in the data storage system;
a processor to enable an authorized user of the licensee to share a link to a received digital certificate in the licensee's folder;
said processor to allow the issuer to set or update an obsolescence characteristics of the digital certificate; and
said processor to enable the user to share the link over a public network via the communications system.

14. The apparatus according to claim 13, further comprising a computer display to display the digital certificate.

15. The apparatus according to claim 13, wherein the data storage system has specific relevance to vehicle registrations, fuel tax reporting, motor carrier, registrant and shipper functions.

16. The apparatus according to claim 13, wherein said processor enables an owner or creator of data to share access to distance information and summaries.

17. The apparatus according to claim 13, wherein said processor tracks accession of data objects.

18. The apparatus according to claim 13, wherein said processor enables an owner or creator of data to share access to distance information, fuel receipts and summaries.

19. The apparatus according to claim 13, wherein said processor enables a participant to be authorized an ability to review, confer accession rights to others, and cause the data or the link to the data to be sent via one or more methods to participants and non-participants.

20. A communications apparatus for enabling one or more organizations to control and share data between and among users while the contributing organization continues to maintain version and access control over the shared data comprising:
non-transitory computer readable media, having encoded thereon instructions to cause a processor to enable an organization of the one or more organizations to deliver a data object to a collection of data objects, to a folder of collections, and to enable the user to share a link to said data object to other systems and other users;
said instructions permitting the other users to verify a creator of the data object and a creation date of the data object;
said instructions including a deliver function, and said deliver function causing the processor to deliver the link to a requested data object along with an associated metadata that identifies a registered owner and a creator of the requested data object;
said instructions causing the processor to register any changed data or new copies of data as a new data object owned by a modifier of the changed data or a creator of the new copy of the data;
said instructions causing the processor to record and verify a date, time, version and secure registration client for each data object;
said object consisting of only an instruction to locate a data file stored under control of the organization;
said instructions to further enable the organization to define an obsolescence characteristic for the object;
said instructions to permit an organization to be self-nominating to the communications apparatus, and to be assigned a private key to identify itself; and
a communications device to send the link to a user's designee.
